(19) United States
(12) Patent Application Publication
(10) Pub. No.: US 2016/0097950 A1
(43) Pub. Date: Apr. 7, 2016

(54) CURVED DISPLAY PANEL

(71) Applicant: Au Optronics Corporation, Hsinchu (TW)

(72) Inventors: Nai-Wen Chang, Taichung City (TW); Chen-Yang Wei, Taichung City (TW); Hung-Che Lin, Hsinchu City (TW); Sheng-Ju Ho, Hsinchu City (TW); Cheng-Han Tsao, New Taipei City (TW); Wen-Lung Chen, Hsinchu County (TW)

(21) Appl. No.: 14/689,050

(22) Filed: Apr. 17, 2015

(30) Foreign Application Priority Data
Oct. 1, 2014 (TW) 103134217

(51) Int. Cl. G02F 1/1335; G02F 1/1343; G02F 1/1368

(52) U.S. Cl. CPC G02F 1/133512; G02F 1/1368; G02F 1/134336

(57) ABSTRACT

A curved display panel bended along a first direction is provided. The curved display panel has a first peripheral area, a center area, and a second peripheral area sequentially arranged along the first direction. The curved display panel includes a first substrate, data lines, scan lines, pixel units, a second substrate opposite to the first substrate, and a display medium disposed between the first substrate and the second substrate. The data lines and the scan lines are crossed to define pixel regions. The pixel units are respectively located in the pixel regions. The aperture ratio of at least one of the pixel regions located in the first peripheral area and the aperture ratio of at least one of the pixel regions located in the second peripheral area are smaller than the aperture ratio of at least one of the pixel regions located in the center area.

### CROSS-REFERENCE TO RELATED APPLICATION

This application claims the priority benefit of Taiwan application serial no. 103134217, filed on Oct. 1, 2014. The entirety of the above-mentioned patent application is hereby incorporated by reference herein and made a part of this specification.

### BACKGROUND OF THE INVENTION

1. Field of the Invention

The invention is related to a display panel, more particularly, to a curved display panel.

2. Description of Related Art

FIG. 1A shows a flat display. FIG. 1B shows a curved display. Referring to FIG. 1A, the display screen of a flat display 10 is flat. When a user S views the display screen of the flat display 10, a distance L1 from a center 1 of the display screen of the flat display 10 to the user S is not equal to a distance L2 from two sides 2 of a display screen 10a to the user S. As a result, the image viewed by the user S is distorted. Therefore, a curved display 20 of FIG. 1B has been proposed. The curved display 20 is catered to the curvature of the retina of the human eye, and when the user S views the curved display 20, a distance L3 from a center 3 of a display screen 20a of the curved display 20 to the retina of the user S is close to a distance L4 from two sides 4 of the display screen 20a of the curved display 20 to the user S. Accordingly, the image viewed by the user S is more vivid, and fatigue of the user S from prolonged viewing is reduced at the same time.

FIG. 2 is a schematic of a known curved display. Referring to FIG. 2, a curved display 30 includes an active device substrate 31, an opposite substrate 32 opposite to the active device substrate 31, and a display medium 33 located between the active device substrate 31 and the opposite substrate 32. In the manufacturing process of the curved display 30, the flat active device substrate 31 and the flat opposite substrate 32 are bended together into an arc surface only after the active device substrate 31 and the opposite substrate 32 are grouped. However, after the active device substrate 31 and the opposite substrate 32 are bended together, the alignment between the members of the active device substrate 31 and the members of the opposite substrate 32 is shifted, thus causing the issue of light leakage of the curved display 30, which is described in the following with FIG. 3A and FIG. 3B.

FIG. 3A shows data lines DL, scan lines SL, an active device T, and a pixel electrode PE of the active device substrate 31 of FIG. 2 located on a left side L of the curved display 30 and a light-shielding structure BM of the corresponding opposite substrate 32. FIG. 3B shows data lines DL, scan lines SL, an active device T, and a pixel electrode PE of the active device substrate 31 of FIG. 2 located on a right side R of the curved display 30 and a light-shielding structure BM of the corresponding opposite substrate 32. Referring to FIG. 2, FIG. 3A, and FIG. 3B, the original intent of the disposition of the light-shielding structure BM is to shield a gap g between the pixel electrode PE and the data lines DL on two sides thereof. However, as shown in FIG. 3A, when the active device substrate 31 and the opposite substrate 32 are bended together into the curved display 30, the gap g between a left-hand side PEL and the data line DL of the pixel electrode PE located on the left side L of the curved display 30 is exposed by the light-shielding structure BM of the opposite substrate 32. As shown in FIG. 3B, the gap g between a right-hand side PER and the data line DL of the pixel electrode PE located on the right side R of the curved display 30 is exposed by the light-shielding structure BM of the opposite substrate 32. As a result, the issue of light leakage occurs to the curved display 30.

### SUMMARY OF THE INVENTION

The invention provides a curved display panel having good performance.

The invention provides a curved display panel. The curved display panel is bended along a first direction. The curved display panel has a first peripheral area, a center area, and a second peripheral area sequentially arranged along the first direction. The curved display panel includes a first substrate, a plurality of data lines disposed on the first substrate, a plurality of scan lines disposed on the first substrate and crossed with the data lines, a plurality of pixel units, a second substrate opposite to the first substrate, and a display medium disposed between the first substrate and the second substrate. The plurality of pixel units are respectively located in a plurality of pixel regions defined by the data lines and the scan lines. Each of the pixel units includes an active device located on the first substrate and a pixel electrode located on the first substrate and electrically connected to the active device. The aperture ratio of at least one of the pixel regions located in the first peripheral area and the aperture ratio of at least one of the pixel regions located in the second peripheral area are smaller than the aperture ratio of at least one of the pixel regions located in the center area.

In an embodiment of the invention, each of the pixel units further includes two light-shielding structures. The two light-shielding structures and the data lines are parallelly disposed and located on two opposite sides of the pixel electrode. The area of the two light-shielding structures of the pixel region located in the first peripheral area inside the pixel region is greater than the area of the two light-shielding structures of the pixel region located in the center area inside the pixel region. The area of the two light-shielding structures of the pixel region located in the second peripheral area inside the pixel region is greater than the area of the two light-shielding structures of the pixel region located in the center area inside the pixel region.

In an embodiment of the invention, the two light-shielding structures of each of the pixel units are located between the display medium and the first substrate.

In an embodiment of the invention, the two light-shielding structures of the pixel region located in the first peripheral area are a first light-shielding structure and a second light-shielding structure. The two light-shielding structures of the pixel region located in the second peripheral area are a third light-shielding structure and a fourth light-shielding structure. The first light-shielding structure, the second light-shielding structure, the third light-shielding structure, and the fourth light-shielding structure are sequentially arranged along the first direction. The linewidth of the first light-shielding structure in the first direction is greater than the linewidth of the second light-shielding structure in the first direction. The linewidth of the fourth light-shielding structure in the first direction is greater than the linewidth of the third light-shielding structure in the first direction.

In an embodiment of the invention, the pixel units are divided into a plurality of first pixel units and a plurality of second pixel units. Each of the first pixel units further includes a first light-shielding structure and a second light-shielding structure. The first light-shielding structure, the pixel electrode of the first pixel unit, and the second light-shielding structure are sequentially arranged along the first direction. The linewidth of the first light-shielding structure in the first direction is greater than the linewidth of the second light-shielding structure in the first direction. Each of the second pixel units further includes a third light-shielding structure and a fourth light-shielding structure. The third light-shielding structure, the pixel electrode of the second pixel unit, and the fourth light-shielding structure are sequentially arranged along the first direction. The linewidth of the fourth light-shielding structure in the first direction is greater than the linewidth of the third light-shielding structure in the first direction.

In an embodiment of the invention, the first pixel units and the second pixel units are arranged in nth to (n+m)th rows along the first direction, and n and m are both positive integers greater than or equal to 1. The number of the first pixel units in the nth row is greater than the number of the first pixel units in the (n+m)th row.

In an embodiment of the invention, the first pixel units and the second pixel units are arranged in nth to (n+m)th rows along the first direction, n and m are both positive integers greater than or equal to 1, and the number of the second pixel units in the nth row is less than the number of the second pixel units in the (n+m)th row.

In an embodiment of the invention, the first pixel units and the second pixel units are randomly distributed.

In an embodiment of the invention, the first pixel units and the second pixel units are arranged into a plurality of rows along the first direction, and the plurality of first pixel units and the plurality of second pixel units in at least one of the rows located in the center portion of the rows are alternately arranged.

In an embodiment of the invention, the number of the first pixel units in the at least one row is the same as the number of the second pixel units in the at least one row.

In an embodiment of the invention, the first pixel units and the second pixel units are arranged into a plurality of rows along the first direction. The plurality of first pixel units in each of the rows located in the first peripheral area are concentrated toward the center of the row that the plurality of first pixel units belong. The number of the first pixel units in each of the rows located in the first peripheral area is reduced with a decrease in distance of the row and the center area. The plurality of second pixel units in each of the rows located in the second peripheral area are concentrated toward the center of the row that the plurality of second pixel units belong. The number of second pixel units in each of the rows located in the second peripheral area is reduced with a decrease in distance of the row and the center area.

In an embodiment of the invention, the first pixel units and the second pixel units are arranged into a plurality of rows along the first direction. A portion of the first pixel units are concentrated in a first area inside the first peripheral area. The width of the first area in a second direction perpendicular to the first direction is increased away from the center area. A portion of the second pixel units are concentrated in a second area inside the second peripheral area. The width of the second area in the second direction is increased away from the center area.

In an embodiment of the invention, a first gap is between the data line closest to the first light-shielding structure of each of the first pixel units and the edge of the pixel electrode of the first pixel unit. A second gap is between the data line closest to the fourth light-shielding structure of each of the second pixel units and the edge of the pixel electrode of the second pixel unit. The curved display panel has a third peripheral area, a fourth peripheral area, a first peripheral area, a center area, a second peripheral area, a fifth peripheral area, and a sixth peripheral area sequentially arranged along the first direction.

In an embodiment of the invention, the area of the first gap of each of the first pixel units located in the center area is R1, the area of the first gap shielded by the first light-shielding structure of the first pixel unit located in the center area is A1, and 0%≦(A1/R1)≦12.5%. The area of the first gap of each of the first pixel units located in the first peripheral area is R2, the area of the first gap shielded by the first light-shielding structure of the first pixel unit located in the first peripheral area is A2, and 12.5%≦(A2/R2)≦81.25%. The area of the first gap of each of the first pixel units located in the fourth peripheral area is R3, the area of the first gap shielded by the first light-shielding structure of the first pixel unit located in the fourth peripheral area is A3, and 81.25%≦(A3/R3)≦100%. The area of the first gap of each of the first pixel units located in the third peripheral area is R4, the area of the first gap shielded by the first light-shielding structure of the first pixel unit located in the third peripheral area is A4, and 0%≦(A4/R4)≦18.75%.

In an embodiment of the invention, the area of the second gap of each of the second pixel units located in the center area is R5, the area of the second gap shielded by the fourth light-shielding structure of the second pixel unit located in the center area is A5, and 0%≦(A5/R5)≦12.5%. The area of the second gap of each of the second pixel units located in the second peripheral area is R6, the area of the second gap shielded by the fourth light-shielding structure of the second pixel unit located in the second peripheral area is A6, and 12.5%≦(A6/R6)≦81.25%. The area of the second gap of each of the second pixel units located in the fifth peripheral area is R7, the area of the second gap shielded by the fourth light-shielding structure of the second pixel unit located in the fifth peripheral area is A7, and 81.25%≦(A7/R7)≦100%. The area of the second gap of each of the second pixel units located in the sixth peripheral area is R8, the area of the second gap shielded by the fourth light-shielding structure of the second pixel unit located in the sixth peripheral area is A8, and 0%≦(A8/R8)≦18.75%.

In an embodiment of the invention, the light-shielding structures are located between the second substrate and the display medium.

In an embodiment of the invention, the curved display panel further includes a network light-shielding pattern. The network light-shielding pattern is located between the second substrate and the display medium and is formed by the intertwinement of a plurality of first network lines parallel to one another and a plurality of second network lines parallel to one another. The first network lines are parallel to the data lines, and the light-shielding structures are the first network lines.

In an embodiment of the invention, the pitch of the two light-shielding structures of the pixel region located in the first peripheral area and the pitch of the two light-shielding structures of the pixel region located in the second peripheral area are smaller than the pitch of the two light-shielding structures of the pixel region located in the center area.

In an embodiment of the invention, the linewidths of the light-shielding structures in the first direction are the same.

In an embodiment of the invention, the linewidths of the two light-shielding structures of the pixel region located in the first peripheral area and the linewidths of the two light-shielding structures of the pixel region located in the second peripheral area are smaller than the linewidths of the two light-shielding structures of the pixel region located in the center area.

In an embodiment of the invention, the relationship between the distance of the pixel region located in the first peripheral area and the center area and the pitch of the two light-shielding structures located inside the pixel region is linear, and the relationship between the distance of the pixel region located in the second peripheral area and the center area and the pitch of the two light-shielding structures located inside the pixel region is linear.

In an embodiment of the invention, the linewidths of the two light-shielding structures of the pixel region located in the first peripheral area and the linewidths of the two light-shielding structures of the pixel region located in the second peripheral area are greater than the linewidths of the two light-shielding structures of the pixel region located in the center area.

In an embodiment of the invention, the light-shielding structures are arranged at an equal pitch.

Based on the above, the curved display panel of an embodiment of the invention is bended along the first direction, and the curved display panel has a first peripheral area, a center area, and a second peripheral area sequentially arranged along the first direction. The aperture ratio of at least one of the pixel regions located in the first peripheral area and the aperture ratio of at least one of the pixel regions located in the second peripheral area are smaller than the aperture ratio of at least one of the pixel regions located in the center area. Via the special design of aperture ratio, the issue of light leakage in the prior art does not readily occur to the curved display panel.

In order to make the aforementioned features and advantages of the disclosure more comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A shows a flat display.

FIG. 1B shows a curved display.

FIG. 2 is a schematic of a known curved display.

FIG. 3A shows data lines, scan lines, an active device, and a pixel electrode of an active device substrate located on the left side of the curved display of FIG. 2 and a light-shielding structure of the corresponding opposite substrate.

FIG. 3B shows data lines, scan lines, an active device, and a pixel electrode of an active device substrate located on the right side of the curved display of FIG. 2 and a light-shielding structure of the corresponding opposite substrate.

FIG. 4 is a schematic of a curved display panel of an embodiment of the invention.

FIG. 5 is a schematic of an active device substrate of the curved display panel of FIG. 4.

FIG. 6 is a schematic of an opposite substrate of the curved display panel of FIG. 4.

FIG. 7A, FIG. 7B, and FIG. 7C respectively show a first pixel region located in a first peripheral area, a first pixel region located in a center area, and a first pixel region located in a second peripheral area.

FIG. 8A shows the first pixel region of an active device substrate of FIG. 7A located in the first peripheral area and a portion of a network light-shielding pattern of an opposite substrate.

FIG. 8B shows the first pixel region of an active device substrate of FIG. 7B located in the center area and a portion of a network light-shielding pattern of an opposite substrate.

FIG. 8C shows the first pixel region of an active device substrate of FIG. 7C located in the second peripheral area and a portion of a network light-shielding pattern of an opposite substrate.

FIG. 9 shows a first pixel unit of another embodiment of the invention.

FIG. 10 shows a first pixel unit of yet another embodiment of the invention.

FIG. 11 shows a second pixel unit of another embodiment of the invention.

FIG. 12 shows a second pixel unit of yet another embodiment of the invention.

FIG. 13 shows the distribution state of first and second pixel units of an embodiment of the invention in a curved display panel.

FIG. 14 shows a plurality of first pixel units and a plurality of second pixel units of FIG. 13 in at least one of the rows located in the center portion of the plurality of rows.

FIG. 15 shows the disposition method of first and second pixel units of another embodiment of the invention in a curved display panel.

FIG. 16 is a schematic of a curved display panel of another embodiment of the invention.

FIG. 17 is a schematic of an active device substrate of the curved display panel of FIG. 16.

FIG. 18 is a schematic of an opposite substrate of the curved display panel of FIG. 16.

FIG. 19A shows a second pixel region of FIG. 18 located in a first peripheral area and data lines, scan lines, an active device, and a pixel electrode below the second pixel region.

FIG. 19B shows a second pixel region of FIG. 18 located in a center area and data lines, scan lines, an active device, and a pixel electrode below the second pixel region.

FIG. 19C shows a second pixel region of FIG. 18 located in a second peripheral area and data lines, scan lines, an active device, and a pixel electrode below the second pixel region.

FIG. 20 shows the relative size of pitch of two first network lines of FIG. 18 on each of the second pixel regions located in a third peripheral area, a first peripheral area, a center area, a second peripheral area, and a fourth peripheral area.

FIG. 21 is a schematic of a curved display panel of yet another embodiment of the invention.

FIG. 22 is a schematic of an active device substrate of the curved display panel of FIG. 21.

FIG. 23 is a schematic of an opposite substrate of the curved display panel of FIG. 21.

FIG. 24A shows a second pixel region of FIG. 21 located in a first peripheral area and data lines, scan lines, an active device, and a pixel electrode below the second pixel region.

FIG. 24B shows a second pixel region of FIG. 21 located in a center area and data lines, scan lines, an active device, and a pixel electrode below the second pixel region.

FIG. 24C shows a second pixel region of FIG. 21 located in a second peripheral area and data lines, scan lines, an active device, and a pixel electrode below the second pixel region.

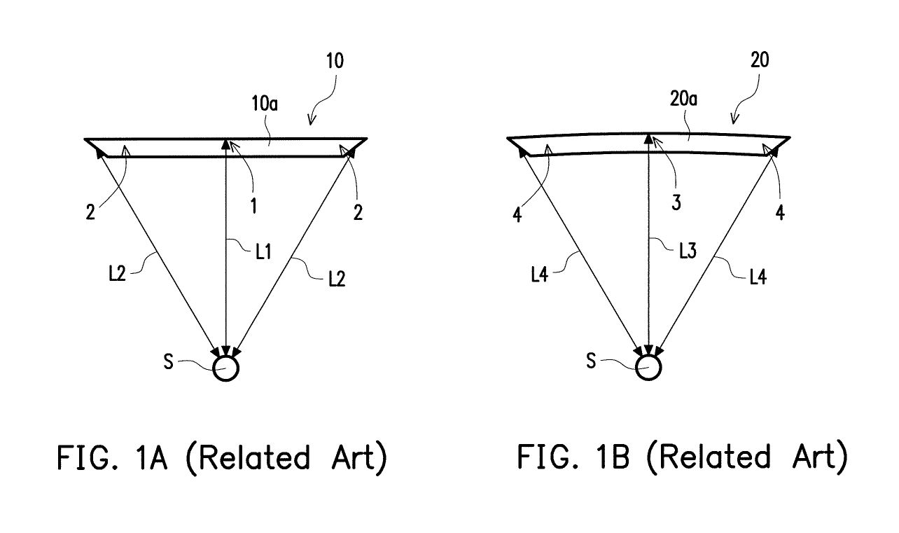

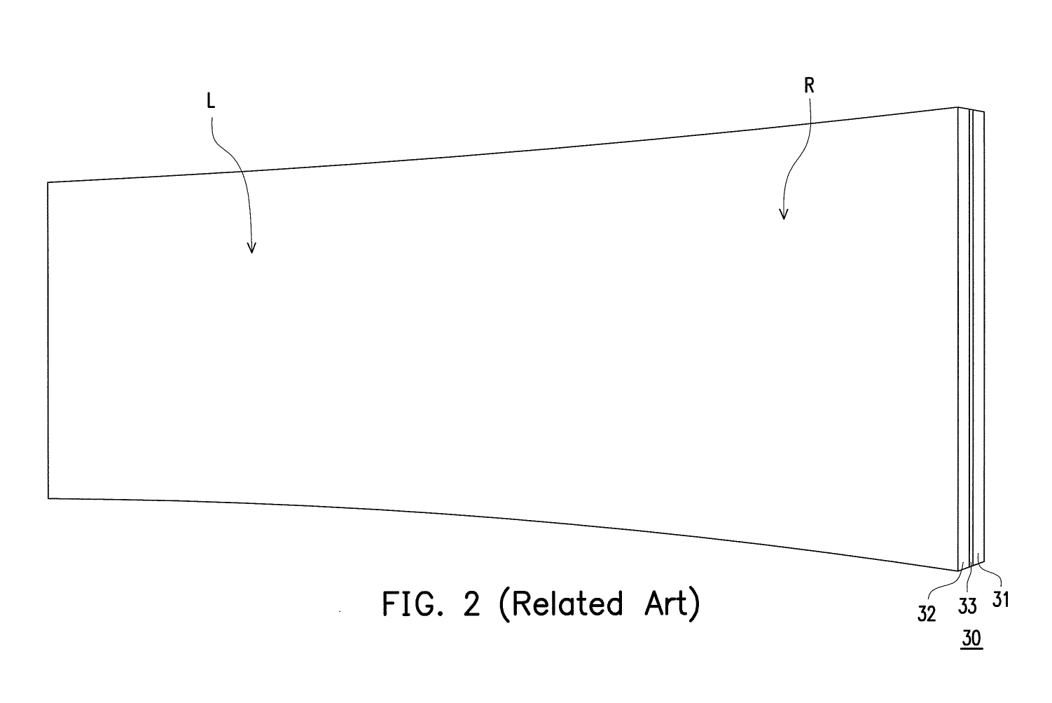

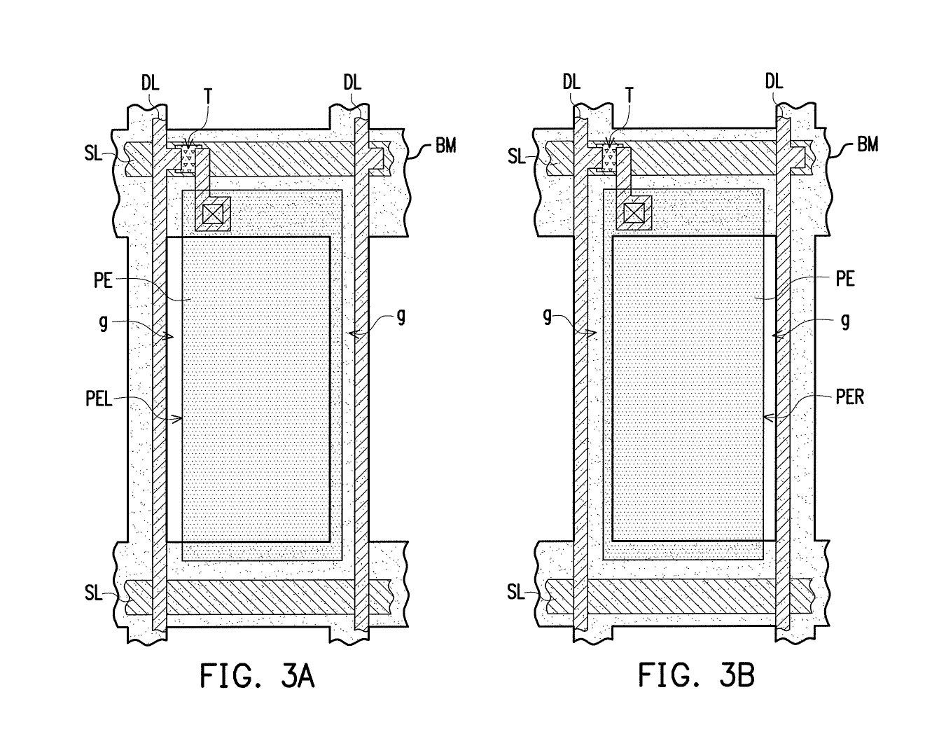

### DESCRIPTION OF THE EMBODIMENTS

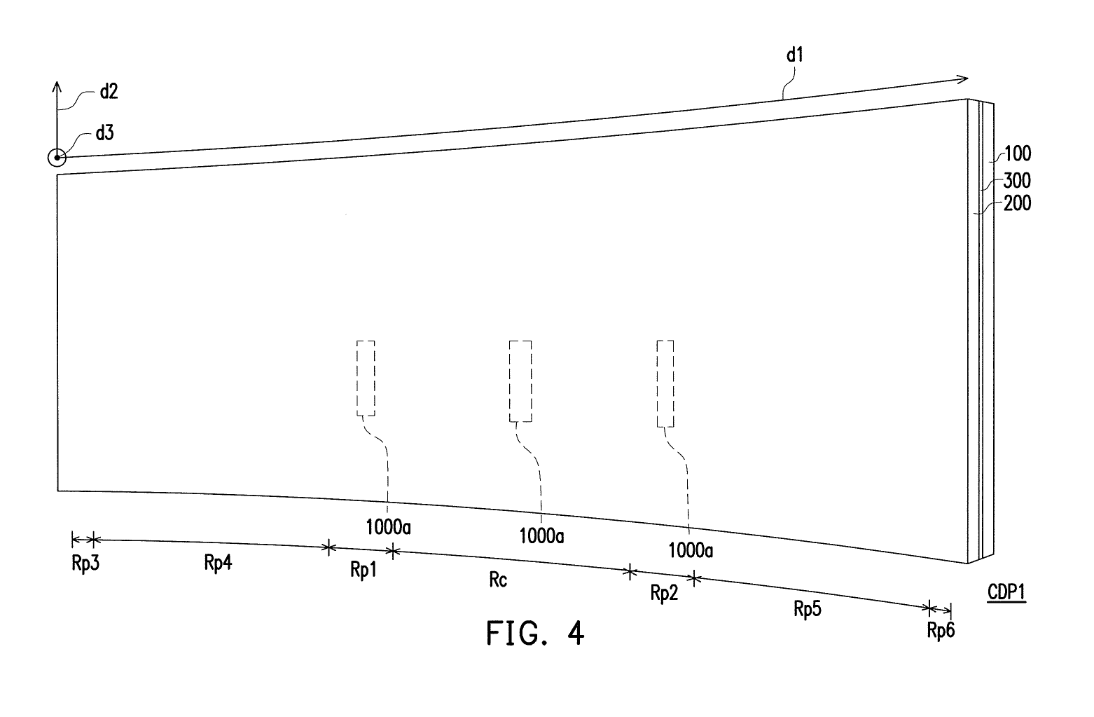

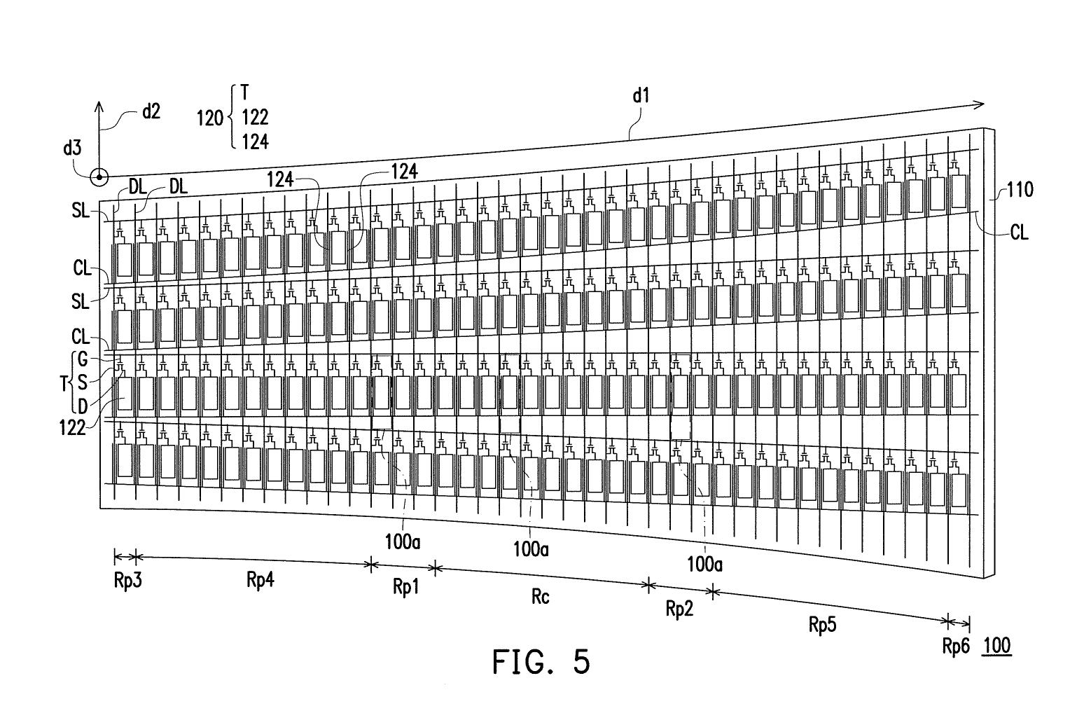

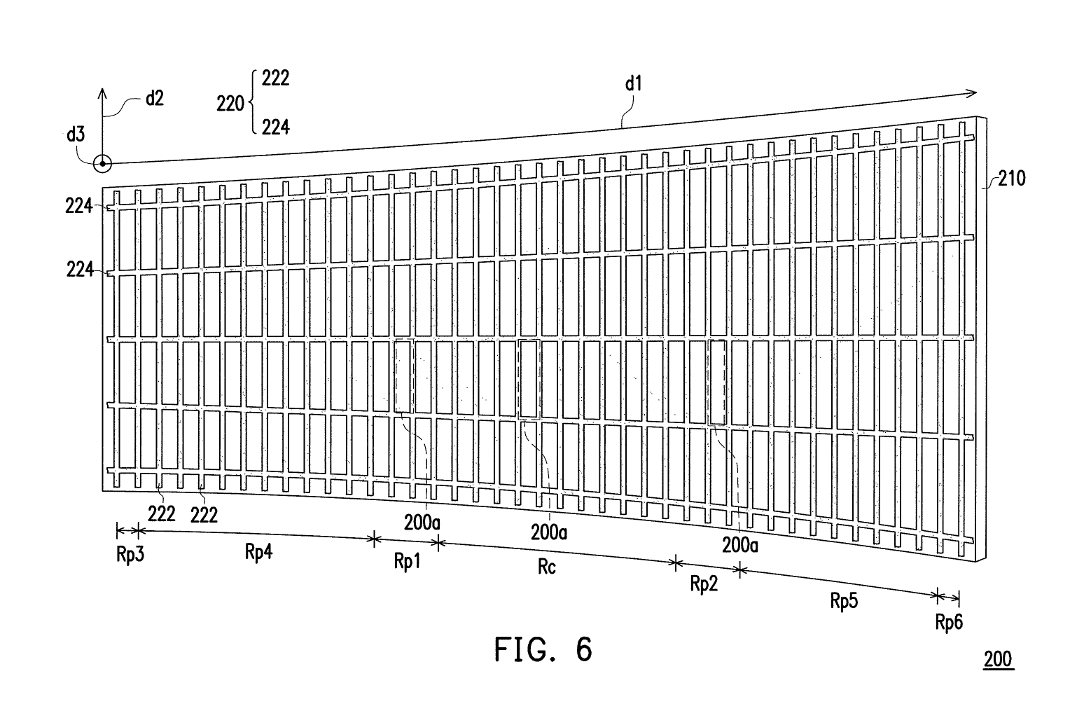

FIG. 4 is a schematic of a curved display panel of an embodiment of the invention. FIG. 5 is a schematic of an active device substrate of the curved display panel of FIG. 4. FIG. 6 is a schematic of an opposite substrate of the curved display panel of FIG. 4. Referring to FIG. 4, FIG. 5, and FIG. 6, a curved display panel CDP1 includes an active device substrate 100, an opposite substrate 200 opposite to the active device substrate 100, and a display medium 300 located between the active device substrate 100 and the opposite substrate 200. In the present embodiment, the display medium 300 is, for instance, a liquid crystal layer. However, the invention is not limited thereto. In other embodiments, the display medium 300 can also be an organic electroluminescent layer, an electrophoretic display layer, or other suitable materials.

The curved display panel CDP1 is bended along a first direction d1. The first direction d1 is an arc line direction. In other words, one of the plurality of scan lines SL and the plurality of data lines DL (such as the plurality of scan lines SL) are respectively located on a plurality of first reference planes parallel to one another, the first reference planes pass through the active device substrate 100, the opposite substrate 200, and the display medium 300, and the sectional line of the curved display panel CDP1 defined by the first reference planes is an arc line. In the present embodiment, the curved display panel CDP1 may be not bended in a second direction d2 perpendicular to the first direction d1. In other words, another one of the plurality of scan lines SL and the plurality of data lines DL (such as the plurality of data lines DL) are respectively located on a plurality of second reference planes parallel to one another, the second reference planes pass through the active device substrate 100, the opposite substrate 200, and the display medium 300, and the sectional line of the curved display panel CDP1 defined by the second reference planes is a straight line. However, the invention is not limited thereto, and in other embodiments, the curved display panel CDP1 can also be bended in the first direction d1 and the second direction d2 at the same time.

The active device substrate 100 includes a first substrate 110, a plurality of data lines DL disposed on the first substrate 110, and a plurality of scan lines SL and a plurality of pixel units 120 disposed on the first substrate 110. The first substrate 110 can be thin glass, an organic polymer, or other suitable materials. The plurality of data lines DL and the plurality of scan lines SL are crossed. In other words, the data lines DL span across the scan lines SL. The data lines DL and the scan lines SL belong to different film layers. Considering electrical conductivity, the scan lines SL and the data lines DL generally include a metal material. However, the invention is not limited thereto. In other embodiments, the scan line SL and the data line DL can also adopt other conductive materials such as an alloy, metal nitride, metal oxide, metal oxynitride, or a stacked layer of a metal material and other conductive materials.

Each of the pixel units 120 at least includes an active device T located on the first substrate 110 and a pixel electrode 122 located on the first substrate 110 and electrically connected to the active device T. The active device T is, for instance, a thin-film transistor (TFT) having a source S, a gate G, and a drain D. The source S of the active device T is electrically connected to the corresponding data line DL. The gate G of the active device T is electrically connected to the corresponding scan line SL. The drain D of the active device T is electrically connected to the corresponding pixel electrode 122. The plurality of pixel units 120 are respectively located in a plurality of pixel regions 1000a defined by the plurality of data lines DL and the plurality of scan lines SL. Each of the pixel regions 1000a includes one first pixel region 100a of the active device substrate 100 and one second pixel region 200a of the opposite substrate 200. Each of the first pixel regions 100a corresponds to one second pixel region 200a. Each of the first pixel regions 100a is defined by two corresponding data lines DL and two corresponding scan lines SL. That is, the boundary of each of the first pixel regions 100a is defined by two corresponding data lines DL and two corresponding scan lines SL. The plurality of first pixel regions 100a are arranged in an array. The plurality of first pixel regions 100a in each column are connected into an arc line along the first direction d1. An axial direction d3 passes through each of the first pixel regions 100a and the center of curvature of the arc line. Each of the first pixel regions 100a forms a first projection on the opposite substrate 200 along the axial direction d3, and the location of the first projection is a second pixel region 200a corresponding to the first pixel region 100a.

The opposite substrate 200 at least includes a second substrate 210 and a network light-shielding pattern 220 disposed between the second substrate 210 and the display medium 300. The network light-shielding pattern 220 is the so-called black matrix. The network light-shielding pattern 220 can be formed by the intertwinement of a plurality of first network lines 222 parallel to one another and a plurality of second network lines 224 parallel to one another. The first network lines 222 can be parallel to the data lines DL, and the second network lines 224 can be parallel to the scan lines SL. The material of the network light-shielding pattern 220 can be black resin, a metal having low reflectivity (such as chromium or nickel), or other suitable materials.

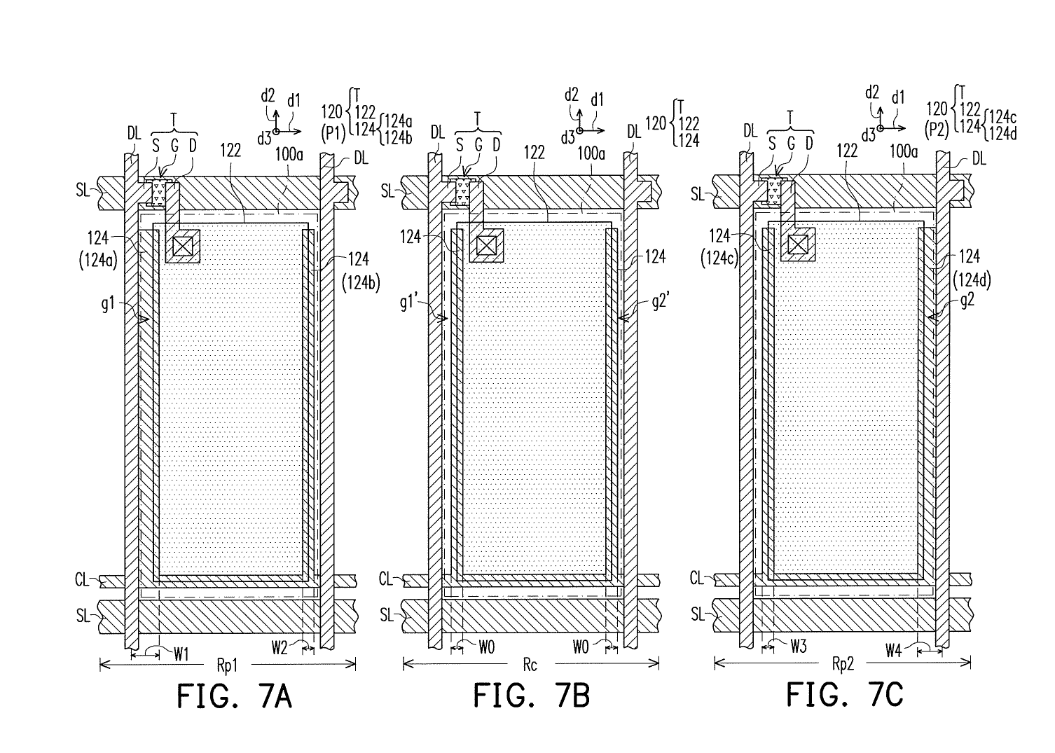

The curved display panel CDP1 has a third peripheral area Rp3, a fourth peripheral area Rp4, a first peripheral area Rp1, a center area Rc, a second peripheral area Rp2, a fifth peripheral area Rp5, and a sixth peripheral area Rp6 sequentially arranged along the first direction d1. In the present embodiment, the curved display panel CDP1 is bended into an arc surface, and the curved display panel CDP1 can optionally be symmetric to a third reference plane passing through the center area Rc. One of a data line DL and a scan line SL (such as a data line DL) is located on the third reference plane. The first, fourth, and third peripheral areas Rp1, Rp4, and Rp3 and the second, fifth, and sixth peripheral areas Rp2, Rp5, and Rp6 are respectively located on two opposite sides of the third reference plane. It should be mentioned that, the aperture ratio of at least one of the pixel regions 1000a located in the first peripheral area Rp1 and the aperture ratio of at least one of the pixel regions 1000a located in the second peripheral area Rp2 are smaller than the aperture ratio of at least one of the pixel regions 1000a located in the center area Rc. More specifically, in the present embodiment, the aperture ratio of at least one of the first pixel regions 100a located in the first peripheral area Rp1 and the aperture ratio of at least one of the first pixel regions 100a located in the second peripheral area Rp2 can be smaller than the aperture ratio of at least one of the first pixel regions 100a located in the center area Rc, which is described in the following with FIG. 7A, FIG. 7B, and FIG. 7C.

FIG. 7A, FIG. 7B, and FIG. 7C respectively show a first pixel region 100a located in the first peripheral area Rp1, a first pixel region 100a located in the center area Rc, and a first pixel region 100a located in the second peripheral area Rp2 of FIG. 5. Referring to FIG. 5, FIG. 7A, and FIG. 7C, in the present embodiment, each of the pixel units 120 further includes two light-shielding structures 124. The light-shielding structures 124 and the data lines DL are parallelly disposed and located on two opposite sides of the pixel electrode 122 of the pixel unit 120 that the light-shielding structures 124 and the data lines DL belong. Referring to FIG. 4, FIG. 5, FIG. 7A, FIG. 7B, and FIG. 7C, the light-shielding structures 124 can be optionally disposed on the active device array substrate 100. In other words, in the present embodiment, the two light-shielding structures 124 of each of the pixel units 120 can be optionally located between the display medium 300 and the first substrate 110. More specifically, the plurality of light-shielding structures 124 of the plurality of pixel units 120 can be electrically connected to one another to form a plurality of common electrode lines CL having reference potential. The light-shielding structures 124 can be overlapped with the pixel electrode 122 of the pixel unit 120 that the light-shielding structures 124 belong so as to be electrically coupled into the storage capacitance of the pixel unit 120.

Referring to FIG. 7A and FIG. 7B, the area of the two light-shielding structures 124 of the first pixel region 100a located in the first peripheral area Rp1 inside the first pixel region 100a that the two light-shielding structures 124 belong is greater than the area of the two light-shielding structures 124 of the first pixel region 100a located in the center area Rc inside the first pixel region 100a that the two light-shielding structures 124 belong. Specifically, in the present embodiment, the two light-shielding structures 124 of the first pixel region 100a located in the first peripheral area Rp1 are a first light-shielding structure 124a and a second light-shielding structure 124b, and the first light-shielding structure 124a and the second light-shielding structure 124b are sequentially arranged along the first direction d1. In particular, a linewidth W1 of the first light-shielding structure 124a in the first direction d1 is greater than a linewidth W2 of the second light-shielding structure 124b in the first direction d1. The linewidths of the two light-shielding structures 124 of the first pixel region 100a located in the center area Rc in the first direction d1 can be W0, and W1>W2≧W0.

As shown in FIG. 7A, a first gap g1 is between a data line DL closest to the first light-shielding structure 124a and the edge of the pixel electrode 122. As shown in FIG. 7B, in the first pixel region 100a of the center area Rc, a gap g1′ is between a data line DL closest to a light-shielding structure 124 located on the left side and the edge of the pixel electrode 122. It can be known from FIG. 7A and FIG. 7B that, the area of the gap g1 of FIG. 7A shielded by the first light-shielding structure 124a is greater than the area of the gap g1′ of FIG. 7B shielded by the light-shielding structure 124 located on the left side of the pixel electrode 122, such that the aperture ratio of at least one of the first pixel regions 100a located in the first peripheral area Rp1 is smaller than the aperture ratio of at least one of the first pixel regions 100a located in the center area Rc.

Referring to FIG. 7B and FIG. 7C, the area of the two light-shielding structures 124 of the first pixel region 100a located in the second peripheral area Rp2 inside the first pixel region 100a that the two light-shielding structures 124 belong is greater than the area of the two light-shielding structures 124 of the first pixel region 100a located in the center area Rc inside the pixel region 100a that the two light-shielding structures 124 belong. Specifically, in the present embodiment, the two light-shielding structures 124 of the first pixel region 100a located in the second peripheral area Rp2 are a third light-shielding structure 124c and a fourth light-shielding structure 124d. The first light-shielding structure 124a, the second light-shielding structure 124b, the third light-shielding structure 124c, and the fourth light-shielding structure 124d are sequentially arranged along the first direction d1. In particular, a linewidth W4 of the fourth light-shielding structure 124d in the first direction d1 is greater than a linewidth W3 of the third light-shielding structure 124c in the first direction d1. More specifically, the linewidths of the two light-shielding structures 124 of the first pixel region 100a located in the center area Rc in the first direction d1 can be W0, and W4>W3≧W0.

As shown in FIG. 7C, a second gap g2 is between a data line DL closest to the fourth light-shielding structure 124d and the edge of the pixel electrode 122. As shown in FIG. 7B, in the first pixel region 100a of the center area Rc, a gap g2′ is between a data line DL closest to the light-shielding structure 124 located on the right side and the edge of the pixel electrode 122. It can be known from FIG. 7B and FIG. 7C that, the area of the second gap g2 of FIG. 7C shielded by the fourth light-shielding structure 124d is greater than the area of the gap g2′ of FIG. 7B shielded by the light-shielding structure 124 located on the right side of the pixel electrode 122, such that the aperture ratio of at least one of the first pixel regions 100a located in the second peripheral area Rp2 is smaller than the aperture ratio of at least one of the first pixel regions 100a located in the center area Rc.

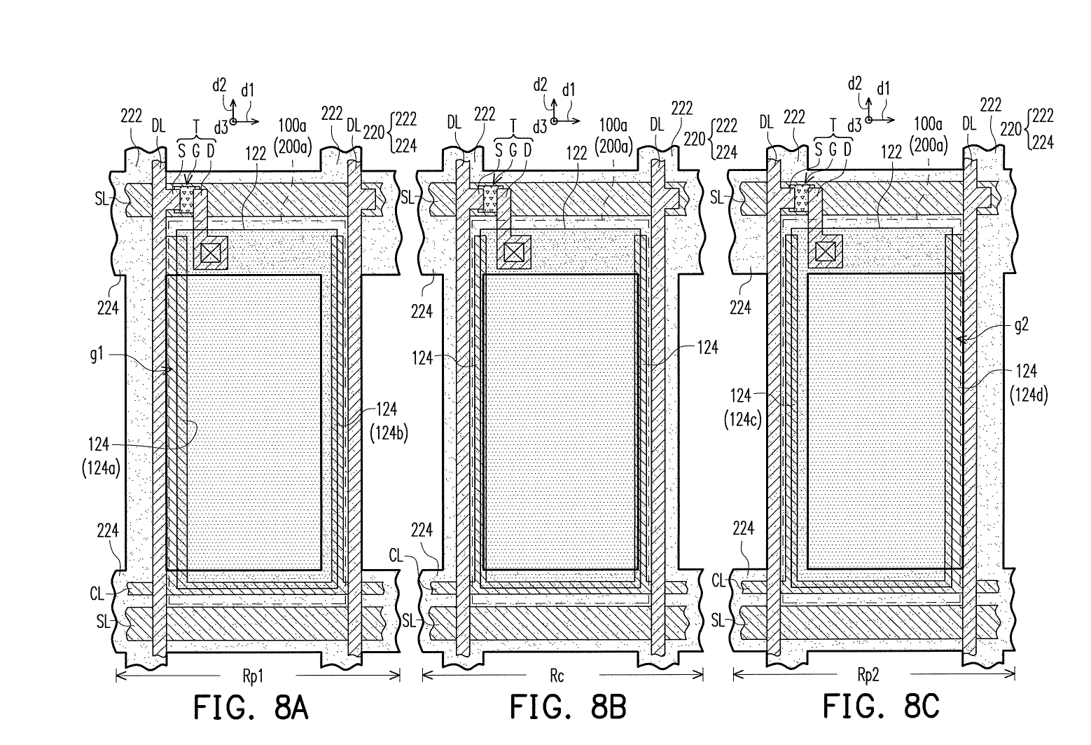

FIG. 8A shows the first pixel region of an active device substrate of FIG. 7A located in the first peripheral area and a portion of a network light-shielding pattern of an opposite substrate. FIG. 8B shows the first pixel region of an active device substrate of FIG. 7B located in the center area and a portion of a network light-shielding pattern of an opposite substrate. FIG. 8C shows the first pixel region of an active device substrate of FIG. 7C located in the second peripheral area and a portion of a network light-shielding pattern of an opposite substrate. Referring to FIG. 4 and FIG. 8A, when the active device substrate 100 and the opposite substrate 200 are bended together into the curved display panel CDP1, the first network lines 222 of the network light-shielding pattern 220 located in the first peripheral area Rp1 are shifted to the left relative to the corresponding data lines DL, and the first network lines 222 cannot completely shield the first gap g1 between the pixel electrode 122 and the data lines DL. At this point, by designing the light-shielding structure 124 (i.e., first light-shielding structure 124a) located on the left side of the pixel electrode 122 to be thicker, the light-shielding structure 124 can compensate the inadequacy of the first network line 222 and thereby shield the first gap g1 between the pixel electrode 122 and the data line DL. As a result, the issue of light leakage in the prior art can be alleviated. Referring to FIG. 4 and FIG. 8C, similarly, when the active device substrate 100 and the opposite substrate 200 are bended together into the curved display panel CDP1, the first network lines 222 of the network light-shielding pattern 220 located in the second peripheral area Rp2 and opposite to the corresponding data lines DL are shifted to the right, and the first network lines 222 cannot effectively shield the second gap g2 between the pixel electrode 122 and the data lines DL. At this point, by designing the light-shielding structure 124 (i.e., fourth light-shielding structure 124b) located on the right side of the pixel electrode 122 to be thicker, the light-shielding structure 124 can compensate the inadequacy of the first network line 222 and thereby shield the second gap g2 between the pixel electrode 122 and the data line DL. As a result, the issue of light leakage in the prior art can be alleviated.

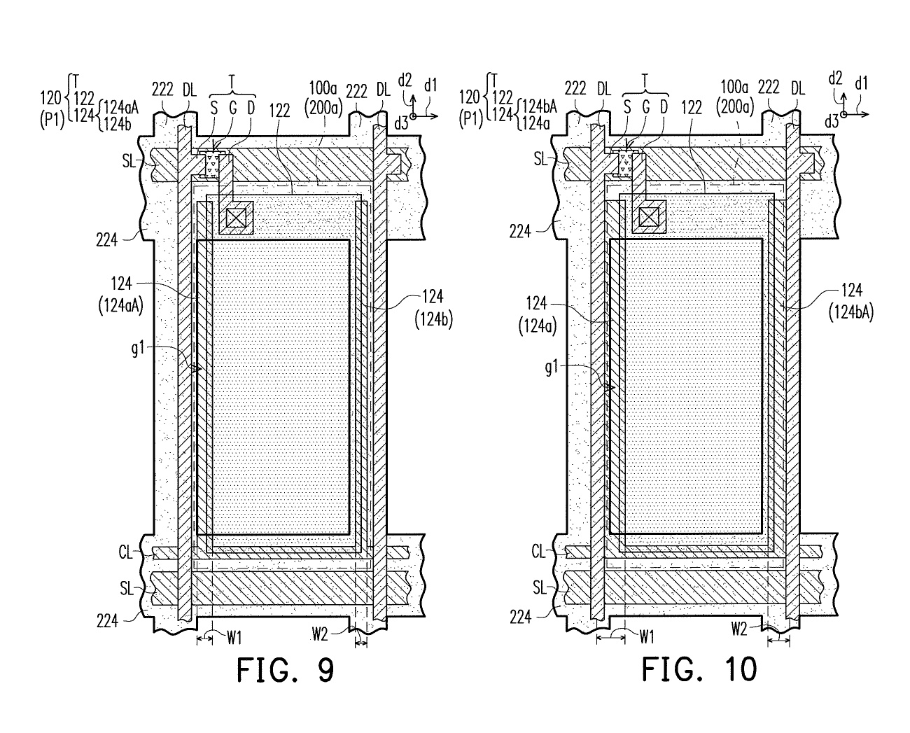

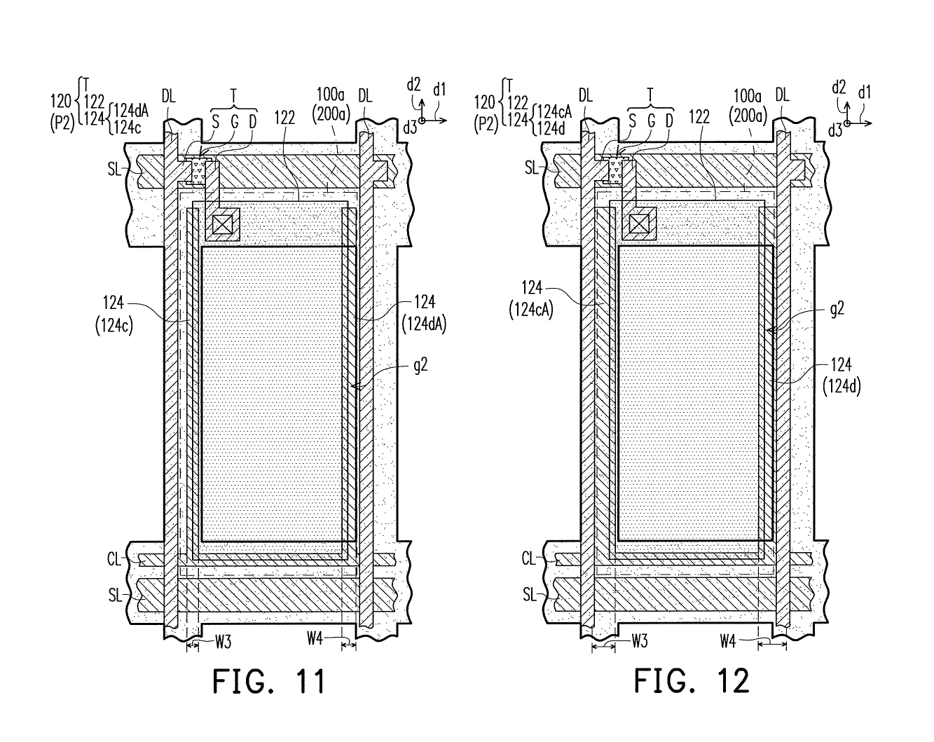

Referring to FIG. 7A, the pixel unit 120 of FIG. 7A can be referred to as a first pixel unit P1. Each of the first pixel units P1 further includes an active device T, a pixel electrode 122 electrically connected to the active device T, a first light-shielding structure 124a, and a second light-shielding structure 124b. In the present embodiment, the first light-shielding structure 124a can be overlapped with the data line DL on the left side of the pixel electrode 122, and the second light-shielding structure 124b can be separated from the data line DL on the right side of the pixel electrode 122. Referring to FIG. 7C, the pixel unit 120 of FIG. 7C can be referred to as a second pixel unit P2. Each of the second pixel units P2 includes an active device T, a pixel electrode 122 electrically connected to the active device T, a third light-shielding structure 124c, and a fourth light-shielding structure 124d. In the present embodiment, the fourth light-shielding structure 124d can be overlapped with the data line DL on the right side of the pixel electrode 122, and the third light-shielding structure 124c can be separated from the data line DL on the left side of the pixel electrode 122. However, the invention is not limited thereto. One of the purposes of the disposition of the first, second, third, and fourth light-shielding structures 124a, 124b, 124c, and 124d is to compensate a shift of the first network lines 222 of the opposite substrate 200 relative to the active device substrate 100, and to shield the gap between the edge of the pixel electrode 122 and the corresponding data lines DL with a plurality of the corresponding first network lines 222. When the degree of bending of the curved display panel CDP1 is different, the shifting situation between the first network lines 222 and the corresponding data lines DL may also be different. At this point, the relative positions between the first, second, third, and fourth light-shielding structures 124a, 124b, 124c, and 124d and the corresponding data lines DL can also be designed as other cases, and the first and second pixel units P1 and P2 can also be in other states. In the following, other possible states of the first pixel units P1 are described with reference to FIG. 9 and FIG. 10, and other possible states of the second pixel units P2 are described with reference to FIG. 11 and FIG. 12.

FIG. 9 shows a first pixel unit of another embodiment of the invention. Each of the members of FIG. 9 is the same or corresponds to each of the members of FIG. 8A, and therefore the same or corresponding members are represented by the same or corresponding reference numerals. A first light-shielding structure 124aA and the second light-shielding structure 124b are sequentially arranged along the first direction d1. The linewidth W1 of the first light-shielding structure 124aA in the first direction d1 is greater than the linewidth W2 of the second light-shielding structure 124b in the first direction d1. In the embodiment of FIG. 9, the first light-shielding structure 124aA can be separated from the data line DL on the left side of the pixel electrode 122, and the second light-shielding structure 124b can be separated from the data line DL on the right side of the pixel electrode 122.

FIG. 10 shows a first pixel unit of yet another embodiment of the invention. Each of the members of FIG. 10 is the same or corresponds to each of the members of FIG. 8A, and therefore the same or corresponding members are represented by the same or corresponding reference numerals. The first light-shielding structure 124a and a second light-shielding structure 124bA are sequentially arranged along the first direction d1. The linewidth W1 of the first light-shielding structure 124a in the first direction d1 is greater than the linewidth W2 of the second light-shielding structure 124bA in the first direction d1. In the embodiment of FIG. 10, the first light-shielding structure 124a can be overlapped with the data line DL on the left side of the pixel electrode 122, and the second light-shielding structure 124bA can be overlapped with the data line DL on the right side of the pixel electrode 122.

FIG. 11 shows a second pixel unit of another embodiment of the invention. Each of the members of FIG. 11 is the same or corresponds to each of the members of FIG. 8C, and therefore the same or corresponding members are represented by the same or corresponding reference numerals. The third light-shielding structure 124c and a fourth light-shielding structure 124dA are sequentially arranged along the first direction d1. The linewidth W4 of the fourth light-shielding structure 124dA in the first direction d1 is greater than the linewidth W3 of the third light-shielding structure 124c in the first direction d1. In the embodiment of FIG. 12, the fourth light-shielding structure 124dA can be separated from the data line DL on the right side of the pixel electrode 122, and the third light-shielding structure 124c can be separated from the data line DL on the left side of the pixel electrode 122.

FIG. 12 shows a second pixel unit of yet another embodiment of the invention. Each of the members of FIG. 12 is the same or corresponds to each of the members of FIG. 8C, and therefore the same or corresponding members are represented by the same or corresponding reference numerals. A third light-shielding structure 124cA and the fourth light-shielding structure 124d are sequentially arranged along the first direction d1. The linewidth W4 of the fourth light-shielding structure 124d in the first direction d1 is greater than the linewidth W3 of the third light-shielding structure 124cA in the first direction d1. In the embodiment of FIG. 12, the fourth light-shielding structure 124d can be overlapped with the data line DL on the right side of the pixel electrode 122, and the third light-shielding structure 124cA can be overlapped with the data line DL on the left side of the pixel electrode 122.

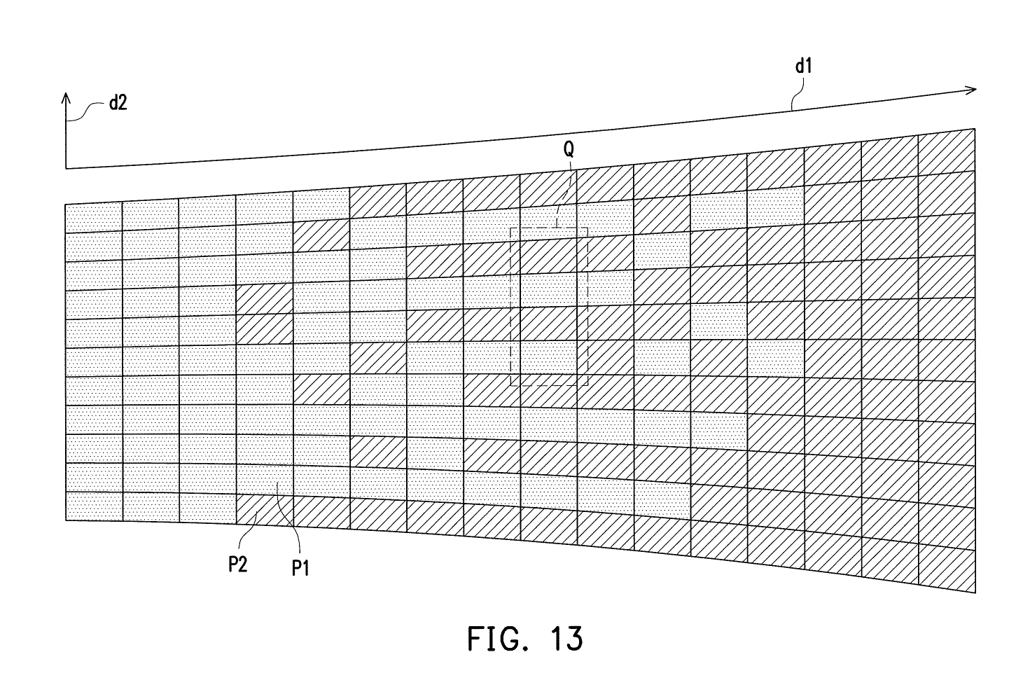

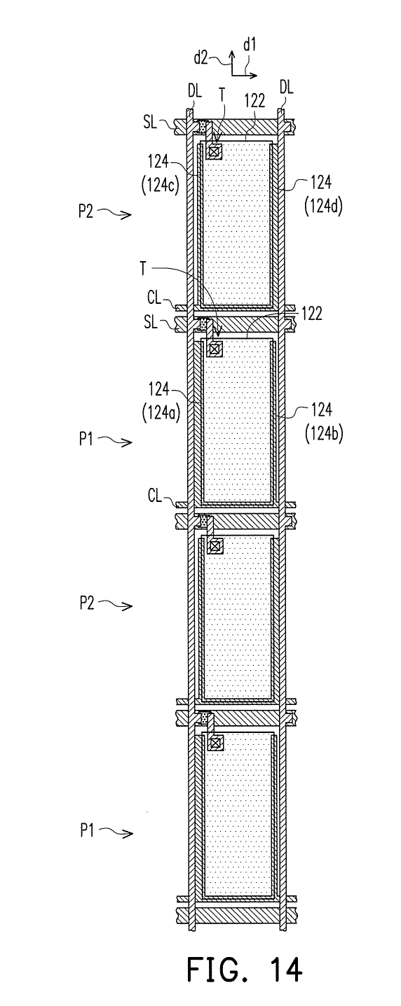

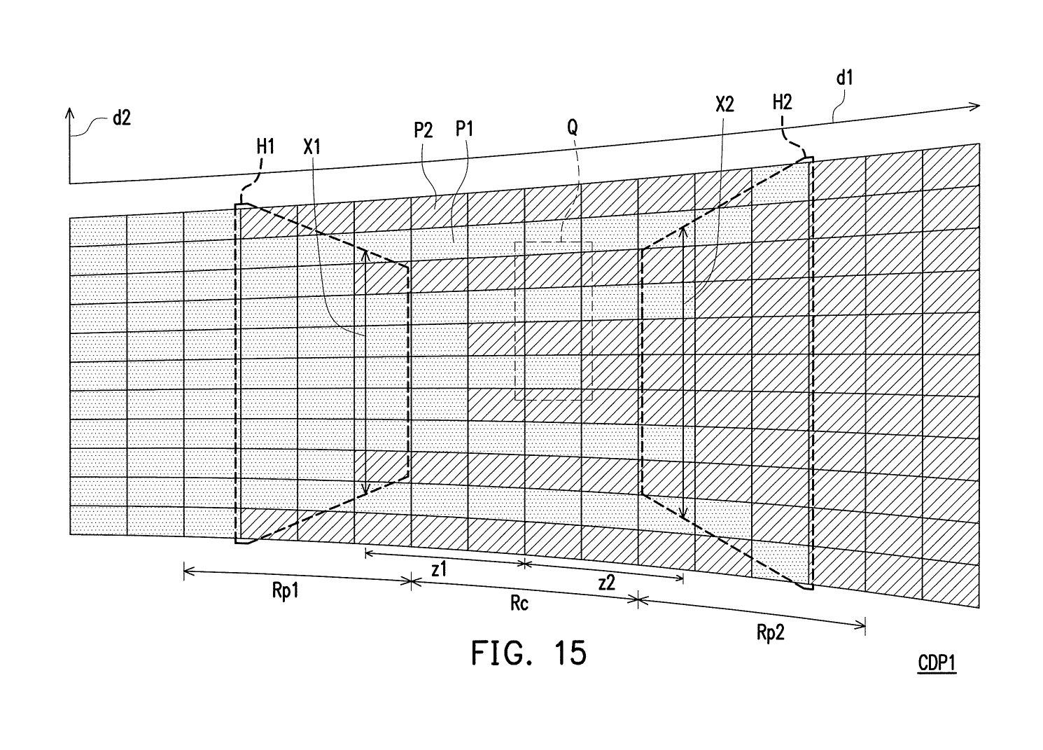

In the present embodiment, the plurality of pixel units 120 can be divided into a plurality of first pixel units and a plurality of second pixel units, wherein the plurality of first pixel units can be the first pixel units P1 of FIG. 7A, the first pixel units P1 of FIG. 9, the first pixel units P1 of FIG. 10, first pixel units of other suitable states, or a combination thereof, and the plurality of second pixel units can be the second pixel units P2 of FIG. 7C, the second pixel units P2 of FIG. 11, the second pixel units P2 of FIG. 12, second pixel units of other suitable states, or a combination thereof. However, the first pixel units P1 are not limited to be disposed in the first peripheral area Rp1, and the second pixel units P2 are not limited to be disposed in the second peripheral area Rp2. The plurality of the first pixel units P1 and the plurality of second pixel units P2 can adapt to the shifting situation of the active device substrate 100 relative to the opposite substrate 200 and be suitably disposed. Description is provided in the following with FIG. 13, FIG. 14, and FIG. 15.

FIG. 13 shows the distribution state of first and second pixel units of an embodiment of the invention in a curved display panel. For ease of explanation, in FIG. 13, the first and second pixel units P1 and P2 are represented via simple rectangular shapes, and the actual layout of the first and second pixel units P1 and P2 is as described above. Referring to FIG. 13, the plurality of first pixel units P1 and the plurality of second pixel units P2 are arranged in nth to (n+m)th rows along the first direction d1, wherein n and m are both positive integers greater than or equal to 1. The number of the plurality of first pixel units P1 in the nth row is greater than the number of the first pixel units P1 in the (n+m)th row. The number of the second pixel units P2 in the nth row is less than the number of the second pixel units P2 in the (n+m)th row of pixels. More specifically, in the embodiment of FIG. 13, the plurality of first pixel units P1 and second pixel units P2 can be randomly distributed in the curved display panel CDP1.

FIG. 14 shows the plurality of first pixel units P1 and the plurality of second pixel units P2 of FIG. 13 in at least one of the rows Q located in the center portion of the plurality of rows. Referring to FIG. 13 and FIG. 14, the plurality of first pixel units P1 and the plurality of second pixel units P2 in at least one of the rows Q located in the center portion of the rows are alternately arranged in the second direction d2. Accordingly, the collection of the plurality of first light-shielding structures 124a of the plurality of first pixel units P1 in at least one of the rows Q and the plurality of third light-shielding structures 124c of the plurality of second pixel units P2 in at least one of the rows Q and the coupling capacitance between the data lines DL located on the left side in at least one of the rows Q, and the collection of the plurality of second light-shielding structures 124b of the plurality of first pixel units P1 in at least one of the rows Q and the plurality of fourth light-shielding structures 124d of the plurality of second pixel units P2 in at least one of the rows Q and the coupling capacitance between the data lines DL located on the right side of at least one row Q can be similar, even the same, thereby facilitating the driving of the curved display panel CDP1.

FIG. 15 shows the disposition method of first and second pixel units of another embodiment of the invention in a curved display panel. In FIG. 15, the first and second pixel units P1 and P2 are also represented via simple rectangular shapes, and the actual layout of the first and second pixel units P1 and P2 is as described above. The plurality of first pixel units P1 and the plurality of second pixel units P2 are arranged in nth to (n+m)th rows along the first direction d1, wherein n and m are both positive integers greater than or equal to 1. The number of the plurality of first pixel units P1 in the nth row is greater than the number of the first pixel units P1 in the (n+m)th row. The number of the second pixel units P2 in the nth row is less than the number of the second pixel units P2 in the (n+m)th row of pixels. In FIG. 15, the disposition method of the plurality of first pixel units P1 and the plurality of second pixel units P2 in at least one of the rows Q located in the center portion of the plurality of rows is the same as that of FIG. 14, and is not repeated herein.

The embodiment of FIG. 15 is different from the embodiment of FIG. 13 in that, in FIG. 15, specifically, the first pixel units P1 in each of the plurality of rows located in the first peripheral area Rp1 are concentrated toward the center of the row that the first pixel units P1 in each of the plurality of rows belong, and the number of the plurality of first pixel units P1 in each of the rows located in the first peripheral area Rp1 is reduced with a decrease in a distance z1 of the row and the center area Rc in the first direction d1; and the second pixel units P2 in each of the plurality of rows located in the second peripheral area Rp2 is concentrated toward the center of the row that the second pixel units P2 in each of the plurality of rows belong, and the number of the second pixel units P2 in each of the plurality of rows located in the second peripheral area Rp2 is reduced with a decrease in a distance z2 of the row and the center area Rc in the first direction d1. From another perspective, a portion of the plurality of first pixel units P1 is concentrated in a first area H1 inside the first peripheral area Rp1, and a width X1 of the first area H1 in the second direction d2 perpendicular to the first direction d1 is increased away from the center area Rc; and a portion of the plurality of second pixel units P2 is concentrated in a second area H2 inside the second peripheral area Rp2, and a width X2 of the second area H2 in the second direction d2 is increased away from the center area Rc.

The detailed structures of the first and second pixel units P1 and P2 in the third peripheral area Rp3, the fourth peripheral area Rp4, the first peripheral area Rp1, the center area Rc, the second peripheral area Rp2, the fifth peripheral area Rp5, and the sixth peripheral area Rp6 of the curved display panel CDP1 sequentially arranged along the first direction d1 are more specifically described below.

Referring to FIG. 7A, a first gap g1 is between a data line DL closest to the first light-shielding structure 124a of each of the first pixel units P1 and the edge of the pixel electrode 122 of the first pixel unit P1. Referring to FIG. 7C, a second gap g2 is between a data line DL closest to the fourth light-shielding structure 124d of each of the second pixel units P2 and the edge of the pixel electrode 122 of the second pixel unit P2. Referring to FIG. 5 and FIG. 7A, the area of the first gap g1 of each of the first pixel units P1 located in the center area Rc is R1, the area of the first gap g1 shielded by the first light-shielding structure 124a of the first pixel unit P1 located in the center area Rc is A1, and 0%≦(A1/R1)≦12.5%. The area of the first gap g1 of each of the first pixel units P1 located in the first peripheral area Rp1 is R2, the area of the first gap g1 shielded by the first light-shielding structure 124a of the first pixel unit P1 located in the first peripheral area Rp1 is A2, and 12.5%≦(A2/R2)≦81.25%. The area of the first gap g1 of each of the first pixel units P1 located in the fourth peripheral area Rp4 is R3, the area of the first gap g1 shielded by the first light-shielding structure 124a of the first pixel unit P1 located in the fourth peripheral area Rp4 is A3, and 81.25%≦(A3/R3)≦100%. The area of the first gap g1 of each of the first pixel units P1 located in the third peripheral area Rp3 is R4, the area of the first gap g1 shielded by the first light-shielding structure 124a of the first pixel unit P1 located in the third peripheral area Rp3 is A4, and 0%≦(A4/R4)≦18.75%.

Referring to FIG. 5 and FIG. 7C, the area of the second gap g2 of each of the second pixel units P2 located in the center area Rc is R5, the area of the second gap g2 shielded by the fourth light-shielding structure 124d of the second pixel unit P2 located in the center area Rc is A5, and 0%≦(A5/R5)≦12.5%. The area of the second gap g2 of each of the second pixel units P2 located in the second peripheral area Rp2 is R6, the area of the second gap g2 shielded by the fourth light-shielding structure 124d of the second pixel unit P2 located in the second peripheral area Rp2 is A6, and 12.5%≦(A6/R6)≦81.25%. The area of the second gap g2 of each of the second pixel units P2 located in the fifth peripheral area Rp5 is R7, the area of the second gap g2 shielded by the fourth light-shielding structure 124d of the second pixel unit P2 located in the fifth peripheral area Rp5 is A7, and 81.25%≦(A7/R7)≦100%. The area of the second gap g2 of each of the second pixel units P2 located in the sixth peripheral area Rp6 is R8, the area of the second gap g2 shielded by the fourth light-shielding structure 124d of the second pixel unit R2 located in the sixth peripheral area Rp3 is A8, and 0%≦(A8/R8)≦18.75%.

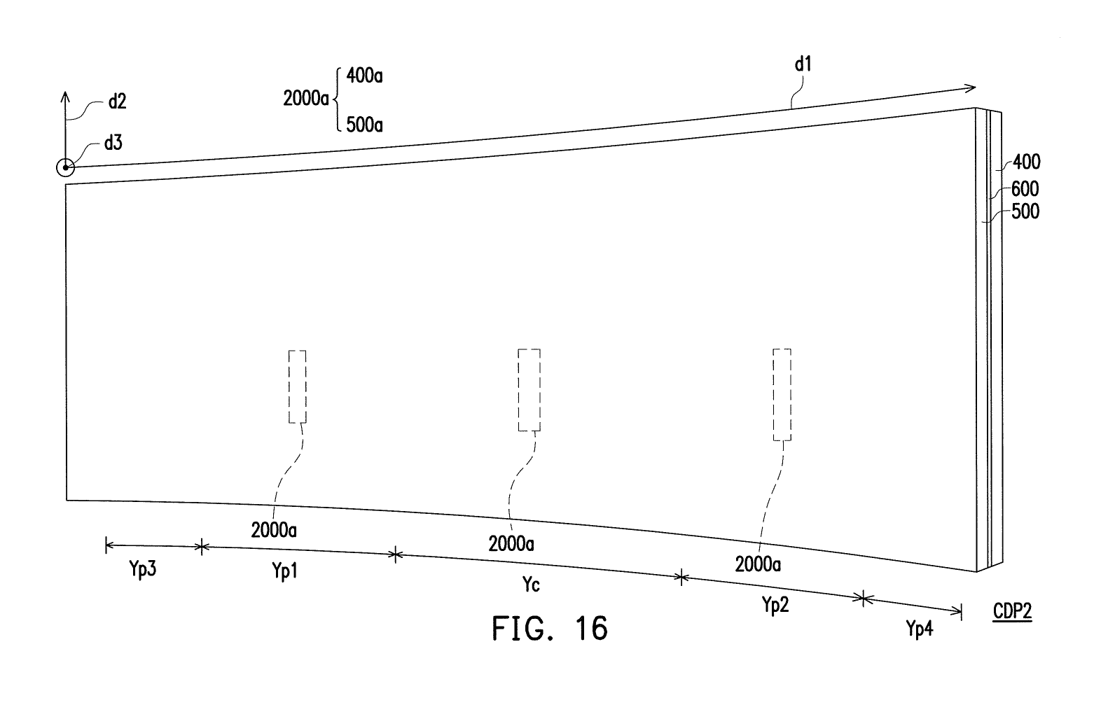

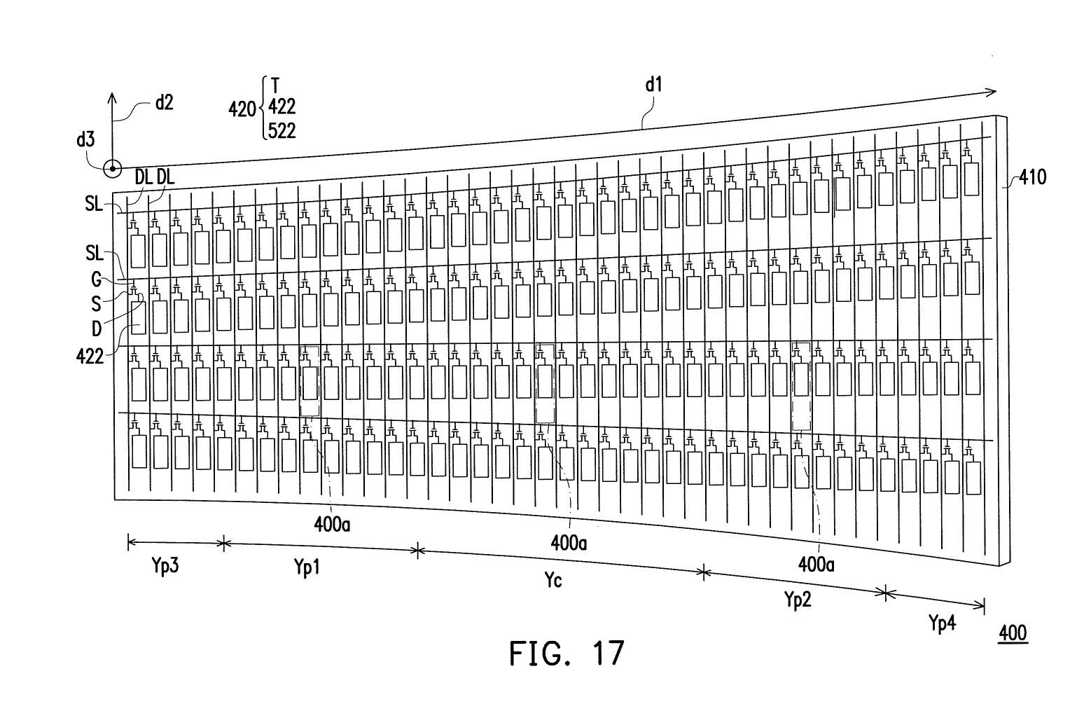

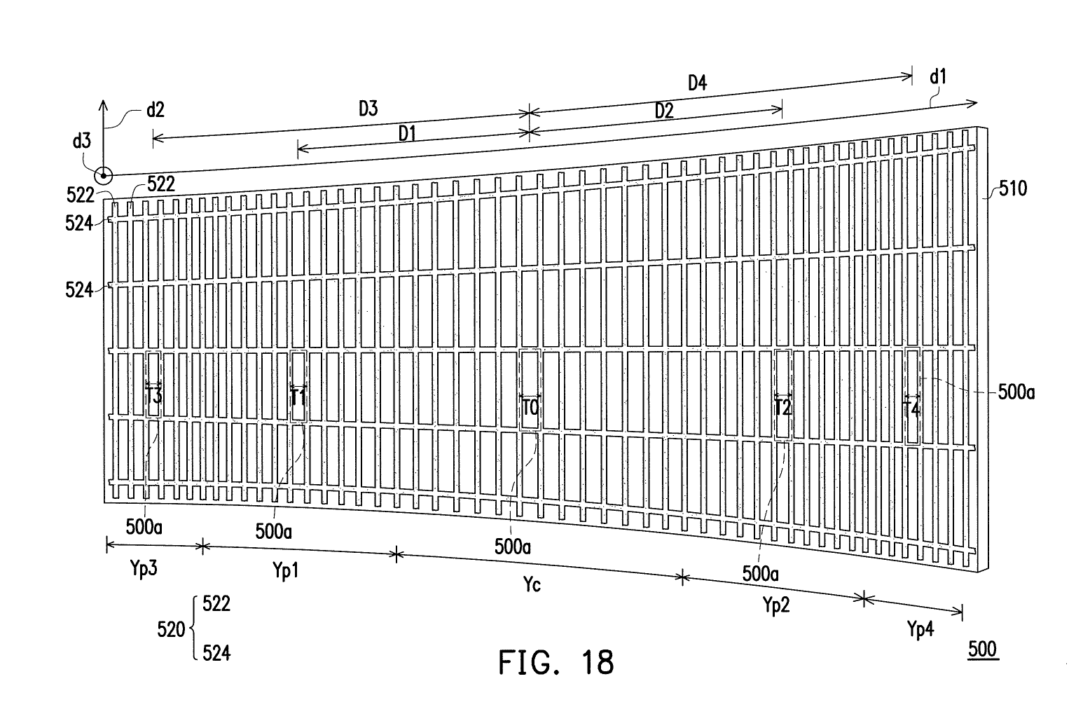

FIG. 16 is a schematic of a curved display panel of another embodiment of the invention. FIG. 17 is a schematic of an active device substrate of the curved display panel of FIG. 16. FIG. 18 is a schematic of an opposite substrate of the curved display panel of FIG. 16. Referring to FIG. 16, FIG. 17, and FIG. 18, a curved display panel CDP2 includes an active device substrate 400, an opposite substrate 500 opposite to the active device substrate 400, and a display medium 600 located between the active device substrate 400 and the opposite substrate 500. In the present embodiment, the display medium 600 is, for instance, a liquid crystal layer. However, the invention is not limited thereto. In other embodiments, the display medium 600 can also be an organic electroluminescent layer, an electrophoretic display layer, or other suitable materials.

The curved display panel CDP2 is bended along the first direction d1. The first direction d1 is an arc line direction. In other words, one of the plurality of scan lines SL and the plurality of data lines DL (such as the plurality of scan lines SL) are respectively located on a plurality of first reference planes parallel to one another, the first reference planes pass through the active device substrate 400, the opposite substrate 500, and the display medium 600, and the sectional line of the curved display panel CDP2 defined by the first reference planes is an arc line. In the present embodiment, the curved display panel CDP2 may be not bended in the second direction d2 perpendicular to the first direction d1. In other words, another one of the plurality of scan lines SL and the plurality of data lines DL (such as the plurality of data lines DL) are respectively located on a plurality of second reference planes parallel to one another, the second reference planes pass through the active device substrate 400, the opposite substrate 500, and the display medium 600, and the sectional line of the curved display panel CDP2 defined by the second reference planes is a straight line. However, the invention is not limited thereto, and in other embodiments, the curved display panel CDP2 can also be bended in the first direction d1 and the second direction d2 at the same time.

The active device substrate 400 includes a first substrate 410, a plurality of data lines DL disposed on the first substrate 410, and a plurality of scan lines SL and a plurality of pixel units 420 disposed on the first substrate 410. The first substrate 410 can be thin glass, an organic polymer, or other suitable materials. The plurality of data lines DL and the plurality of scan lines SL are crossed. In other words, the data lines DL span across the scan lines SL. The data lines DL and the scan lines SL belong to different film layers. Considering electrical conductivity, the scan lines SL and the data lines DL generally include a metal material. However, the invention is not limited thereto. In other embodiments, the scan line SL and the data line DL can also adopt other conductive materials such as an alloy, metal nitride, metal oxide, metal oxynitride, or a stacked layer of a metal material and other conductive materials.

Each of the pixel units 420 at least includes an active device T located on the first substrate 410 and a pixel electrode 422 located on the first substrate 410 and electrically connected to the active device T. The active device T is, for instance, a TFT having a source S, a gate G, and a drain D. The source S of the active device T is electrically connected to the corresponding data line DL. The gate G of the active device T is electrically connected to the corresponding scan line SL. The drain D of the active device T is electrically connected to the corresponding pixel electrode 422. The plurality of pixel units 420 are respectively located on a plurality of pixel regions 2000a defined by the plurality of data lines DL and the plurality of scan lines SL. Each of the pixel regions 2000a includes one first pixel region 400a of the active device substrate 400 and one second pixel region 500a of the opposite substrate 500. Each of the first pixel regions 400a corresponds to one second pixel region 500a. Each of the first pixel regions 400a is defined by two corresponding data lines DL and two corresponding scan lines SL. That is, the boundary of each of the first pixel regions 400a is defined by two corresponding data lines DL and two corresponding scan lines SL. The plurality of first pixel regions 400a are arranged in an array. Each column of the plurality of first pixel regions 400a is connected into an arc line along the first direction d1. An axial direction d3 passes through each of the first pixel regions 400a and the center of curvature of the arc line. Each of the first pixel regions 400a forms a first projection on the opposite substrate 500 along the axial direction d3, and the location of the first projection is a second pixel region 500a corresponding to the first pixel region 400a.

The opposite substrate 500 at least includes a second substrate 510 and a network light-shielding pattern 520 disposed between the second substrate 510 and the display medium 600. The network light-shielding pattern 520 is the so-called black matrix. The network light-shielding pattern 520 can be formed by the intertwinement of a plurality of first network lines 522 parallel to one another and a plurality of second network lines 524 parallel to one another. The first network lines 522 and the second network lines 524 are both located between the second substrate 510 and the display medium 600. The first network lines 522 can be parallel to the data lines DL, and the second network lines 524 can be parallel to the scan lines SL. The material of the network light-shielding pattern 220 can be black resin, a metal having low reflectivity (such as chromium or nickel), or other suitable materials. Each of the pixel units 420 further includes a plurality of light-shielding structures located in the corresponding second pixel region 500a, and in the present embodiment, the light-shielding structures can be located on two opposite sides of the pixel electrode 422 and be two first network lines 522 disposed parallel to the data lines DL.

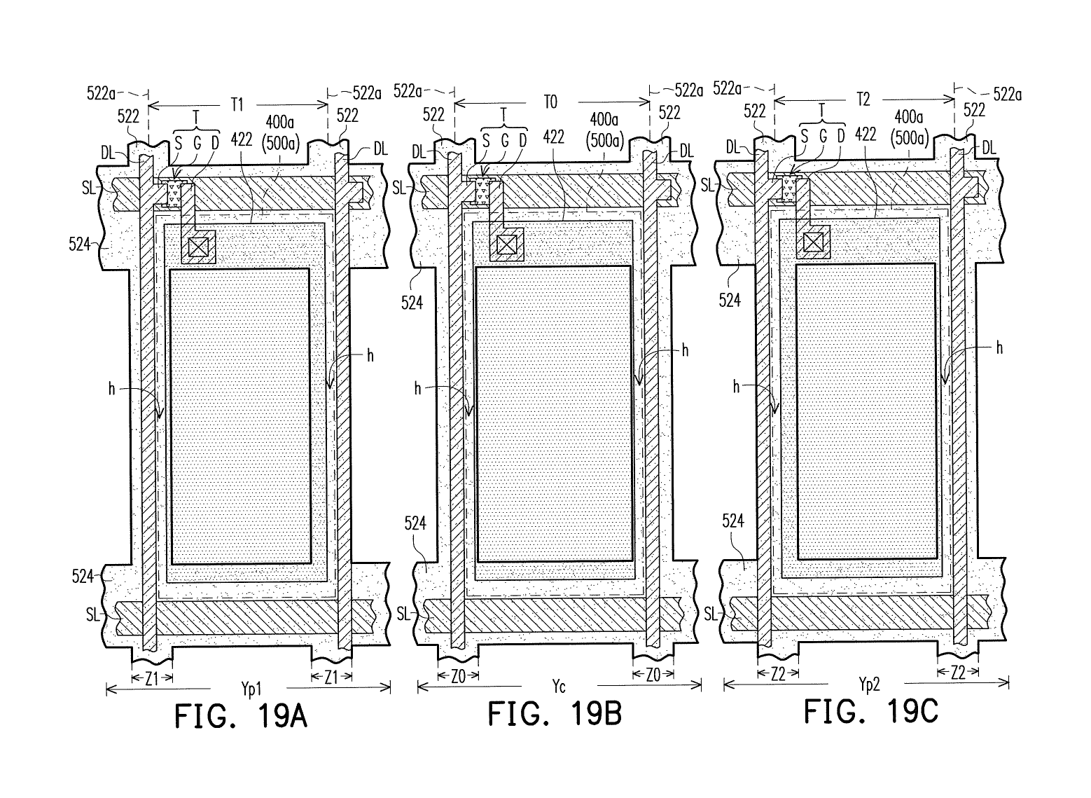

The curved display panel CDP2 has a third peripheral area Yp3, a first peripheral area Yp1, a center area Yc, a second peripheral area Yp2, and a fourth peripheral area Yp4 sequentially arranged along the first direction d1. In the present embodiment, the curved display panel CDP2 is bended into an arc surface, and the curved display panel CDP2 can be symmetric to a third reference plane passing through the center area Yc. One of a data line DL and a scan line SL (such as a data line DL) is located on the third reference plane. The first and third peripheral areas Yp1 and Yp3 and the second and fourth peripheral areas Yp2 and Yp4 are respectively located on two opposite sides of the third reference plane. It should be mentioned that, the aperture ratio of at least one of the pixel regions 2000a located in the first peripheral area Yp1 and the aperture ratio of at least one of the pixel regions 2000a located in the second peripheral area Yp2 are smaller than the aperture ratio of at least one of the pixel regions 2000a located in the center area Yc. More specifically, in the present embodiment, the aperture ratio of at least one of the second pixel regions 500a located in the first peripheral area Yp1 and the aperture ratio of at least one of the second pixel regions 500a located in the second peripheral area Yp2 can be smaller than the aperture ratio of at least one of the second pixel regions 500a located in the center area Yc, which is described in the following with FIG. 19A, FIG. 19B, and FIG. 19C.

FIG. 19A shows a second pixel region of FIG. 18 located in a first peripheral area and data lines, scan lines, an active device, and a pixel electrode below the second pixel region. FIG. 19B shows a second pixel region of FIG. 18 located in a center area and data lines, scan lines, an active device, and a pixel electrode below the second pixel region. FIG. 19C shows a second pixel region of FIG. 18 located in a second peripheral area and data lines, scan lines, an active device, and a pixel electrode below the second pixel region. Referring to FIG. 19A, FIG. 19B, and FIG. 19C, the area of the two first network lines 522 of the second pixel region 500a located in the first peripheral area Yp1 inside the second pixel region 500a that the two first network lines 522 belong is greater than the area of the two first network lines 522 of the second pixel region 500a located in the center area Yc inside the second pixel region 500a that the two first network lines 522 belong. Therefore, the aperture ratio of at least one of the second pixel regions 500a located in the first peripheral area Yp1 is smaller than the aperture ratio of at least one of the second pixel regions 500a located in the center area Yc. The area of the two first network lines 522 of the second pixel region 500a located in the second peripheral area Yp2 inside the second pixel region 500a that the two first network lines 522 belong is greater than the area of the two first network lines 522 of the second pixel region 500a located in the center area Yc inside the second pixel region 500a that the two first network lines 522 belong. Therefore, the aperture ratio of at least one of the second pixel regions 500a located in the second peripheral area Yp2 is smaller than the aperture ratio of at least one of the second pixel regions 500a located in the center area Yc.

More specifically, a pitch T1 of the two first network lines 522 of the second pixel region 500a located in the first peripheral area Yp1 in the first direction d1 and a pitch T2 of the two first network lines 522 of the second pixel region 500a located in the first peripheral area Yp1 in the first direction d1 are smaller than a pitch T0 of the two first network lines 522 of the second pixel region 500a located in the center area Yc in the first direction d1, wherein the pitches T0, T1, and T2 refer to the distances of two central axes 522a of two corresponding first network lines 522 in the first direction d1. The direction of extension of each of the central axes 522a is the same as the direction of extension of a corresponding first network line 522, and each of the central axes 522a passes through the geometric center of a corresponding first network line 522. At this point, not only do the two first network lines 522 on the second pixel region 500a located in the center area Yc shield a gap h between the pixel electrode 422 and the two data lines DL, the two first network lines 522 of the second pixel region 500a located in the first and second peripheral areas Yp1 and Yp2 also shield the gap h between the corresponding pixel electrode 422 and two data lines DL. As a result, the issue of light leakage in the prior art is alleviated.

In the present embodiment, the photomask used to manufacture the plurality of first network lines 522 located in the first and second peripheral areas Yp1 and Yp2 and the photomask used to manufacture the plurality of first network lines 522 located in the center area Yc may be different, and linewidths Z1, Z2, and Z0 of the plurality of first network lines 522 of each of the second pixel regions 500a located in the first peripheral area Yp1 and the two first network lines 522 of each of the second pixel regions 500a located in the center area Yc in the first direction d1 may be the same. However, the invention is not limited thereto. In other embodiments, the photomask used to manufacture the plurality of first network lines 522 located in the first and second peripheral areas Yp1 and Yp2 and the photomask used to manufacture the plurality of first network lines 522 located in the center area Yc can also be the same photomask, and the plurality of first network lines 522 having different pitch and respectively located in the first and second peripheral areas Yp1 and Yp2 and the center area Yc are manufactured via a method in which lithography process parameters are changed. At this point, the linewidths of the first network lines 522 of each of the second pixel regions 500a located in the first and second peripheral areas Yp1 and Yp2 are smaller than the linewidths of the first network lines 522 of each of the second pixel regions 500a located in the center area Yc.

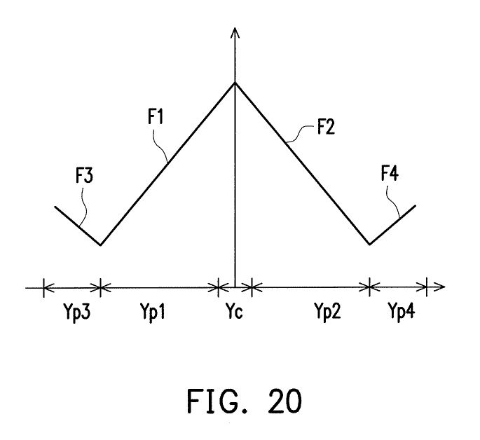

FIG. 20 shows the relative size of pitch of the two first network lines 522 of FIG. 18 on each of the second pixel regions 500a located in the third peripheral area Yp3, the first peripheral area Yp1, the center area Yc, the second peripheral area Yp2, and the fourth peripheral area Yp4. Referring to FIG. 18 and FIG. 20, in the curved display panel CDP2, the relationship between a distance D1 of each of the second pixel regions 500a located in the first peripheral area Yp1 and the center area Yc and the pitch T1 of the two first network lines 522 in the second pixel region 500a is linear. More specifically, the relationship between the distance D1 of each of the second pixel regions 500a located in the first peripheral area Yp1 and the center area Yc and the pitch T1 of the two first network lines 522 in the second pixel region 500a is a decreasing function F1. The relationship between a distance D3 of the two first network lines 522 of each of the second pixel regions 500a located in the third peripheral area Yp3 and the center area Yc and a pitch T3 of the two first network lines 522 in the second pixel region 500a is also linear, wherein the pitch T3 refers to the distance of two central axes of two corresponding first network lines 522 in the first direction d1. Specifically, the relationship between the distance D3 of the two first network lines 522 of the second pixel region 500a located in the third peripheral area Yp3 and the center area Yc and the pitch T3 of the two first network lines 522 is an increasing function F3. The third peripheral area Yp3 is adjacent to the edge of the display area of the curved display panel CDP2, that is, the third peripheral area Yp3 is adjacent to the seal, wherein the seal is disposed between the active device substrate 400 and the opposite substrate 500 and surrounds the display medium 600.

Similarly, in the curved display panel CDP2, the relationship between the distance D2 of the two first network lines 522 of each of the second pixel regions 500a located in the second peripheral area Yp2 and the center area Yc and the pitch T2 of the two first network lines 522 is linear. More specifically, the relationship between the distance D2 of the two first network lines 522 of the second pixel region 500a located in the second peripheral area Yp2 and the center area Yc and the pitch T2 of the two first network lines 522 is a decreasing function F2. The relationship between a distance D4 of the two first network lines 522 of each of the second pixel regions 500a located in the fourth peripheral area Yp4 and the center area Yc and a pitch T4 of the two first network lines 522 is also linear, wherein the pitch T4 refers to the distance of two central axes of two corresponding first network lines 522 in the first direction d1. Specifically, the relationship between the distance D4 of the two first network lines 522 of the second pixel region 500a located in the fourth peripheral area Yp4 and the center area Yc and the pitch T4 of the two first network lines 522 is an increasing function F4. The fourth peripheral area Yp4 is adjacent to the edge of the display area of the curved display panel CDP2, that is, the fourth peripheral area Yp4 is adjacent to the seal, wherein the seal is disposed between the active device substrate 400 and the opposite substrate 500 and surrounds the display medium 600.

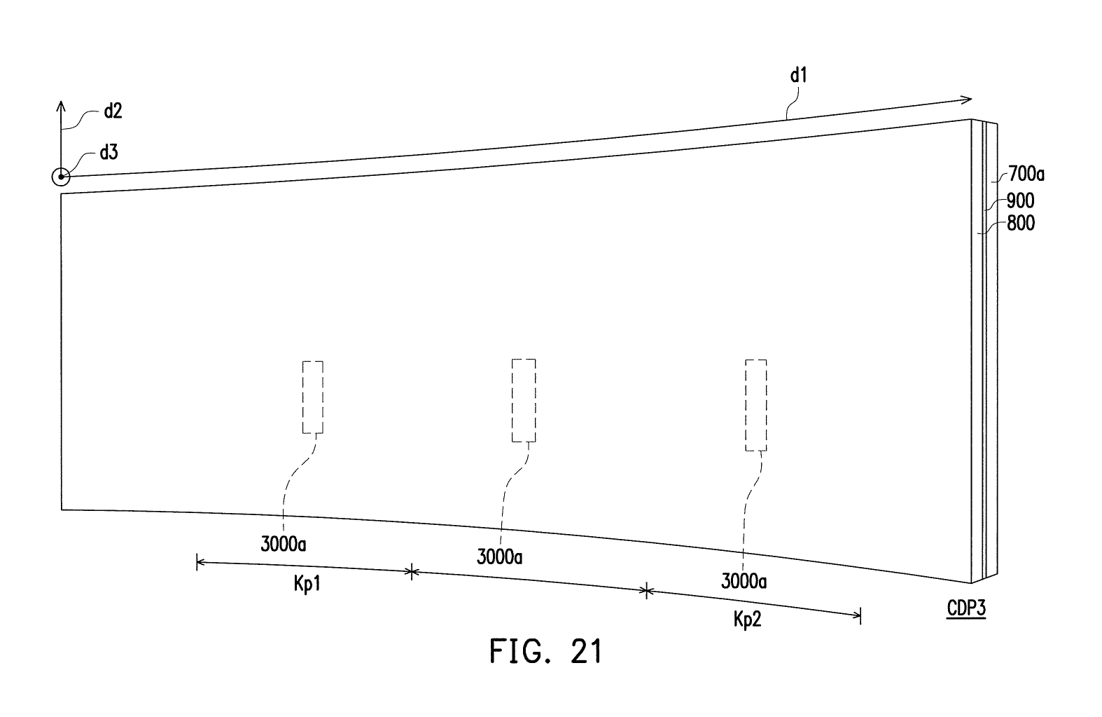

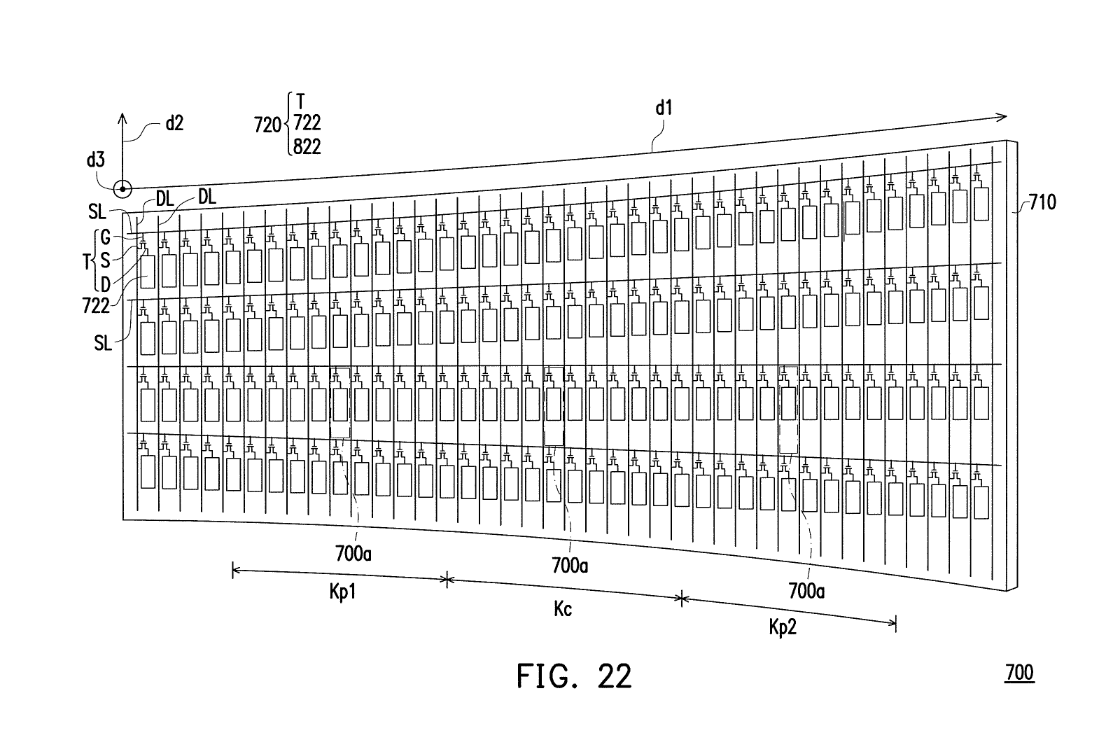

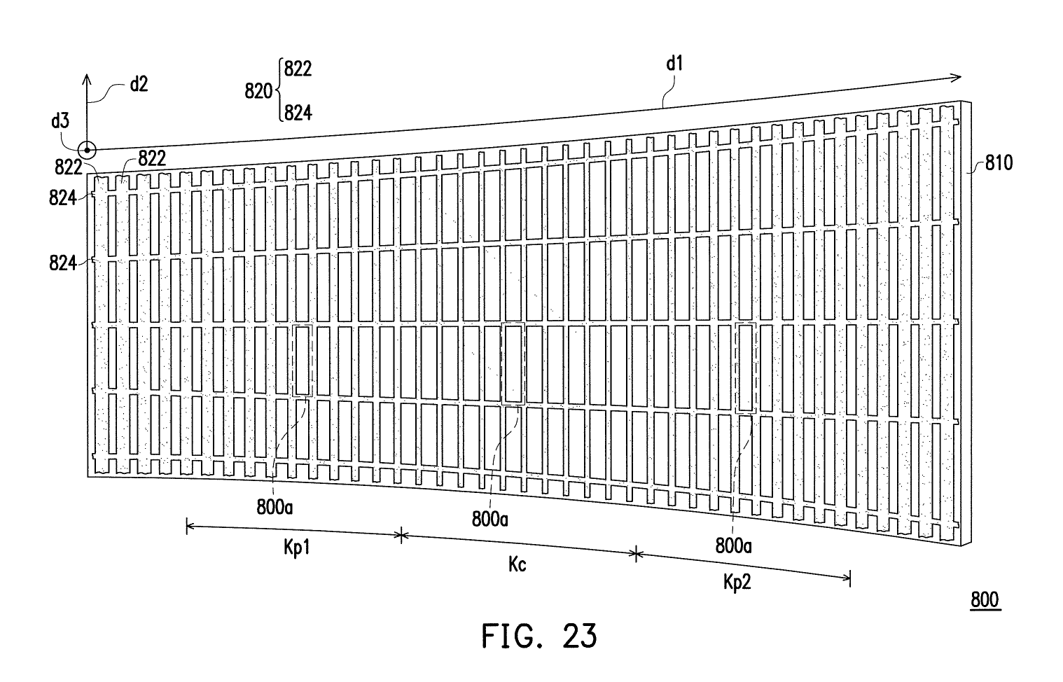

FIG. 21 is a schematic of a curved display panel of yet another embodiment of the invention. FIG. 22 is a schematic of an active device substrate of the curved display panel of FIG. 21. FIG. 23 is a schematic of an opposite substrate of the curved display panel of FIG. 21. Referring to FIG. 21, FIG. 22, and FIG. 23, a curved display panel CDP3 includes an active device substrate 700, an opposite substrate 800 opposite to the active device substrate 700, and a display medium 900 located between the active device substrate 700 and the opposite substrate 800. In the present embodiment, the display medium 900 is, for instance, a liquid crystal layer. However, the invention is not limited thereto. In other embodiments, the display medium 900 can also be an organic electroluminescent layer, an electrophoretic display layer, or other suitable materials.

The curved display panel CDP3 is bended along the first direction d1. The first direction d1 is an arc line direction. In other words, one of the plurality of scan lines SL and the plurality of data lines DL (such as the plurality of scan lines SL) are respectively located on a plurality of first reference planes parallel to one another, the first reference planes pass through the active device substrate 700, the opposite substrate 800, and the display medium 900, and the sectional line of the curved display panel CDP3 defined by the first reference planes is an arc line. In the present embodiment, the curved display panel CDP3 may be not bended in the second direction d2 perpendicular to the first direction d1. In other words, another one of the plurality of scan lines SL and the plurality of data lines DL (such as the plurality of data lines DL) are respectively located on a plurality of second reference planes parallel to one another, the second reference planes pass through the active device substrate 700, the opposite substrate 800, and the display medium 900, and the sectional line of the curved display panel CDP3 defined by the second reference planes is a straight line. However, the invention is not limited thereto, and in other embodiments, the curved display panel CDP3 can also be bended in the first and second directions d1 and d2 at the same time.

The active device substrate 700 includes a first substrate 710, a plurality of data lines DL disposed on the first substrate 710, and a plurality of scan lines SL and a plurality of pixel units 720 disposed on the first substrate 710. The first substrate 710 can be thin glass, an organic polymer, or other suitable materials. The plurality of data lines DL and the plurality of scan lines SL are crossed. In other words, the data lines DL span across the scan lines SL. The data lines DL and the scan lines SL belong to different film layers. Considering electrical conductivity, the scan lines SL and the data lines DL generally include a metal material. However, the invention is not limited thereto. In other embodiments, the scan line SL and the data line DL can also adopt other conductive materials such as an alloy, metal nitride, metal oxide, metal oxynitride, or a stacked layer of a metal material and other conductive materials.

Each of the pixel units 720 at least includes an active device T located on the first substrate 710 and a pixel electrode 722 located on the first substrate 710 and electrically connected to the active device T. The active device T is, for instance, a TFT having a source S, a gate G, and a drain D. The source S of the active device T is electrically connected to the corresponding data line DL. The gate G of the active device T is electrically connected to the corresponding scan line SL. The drain D of the active device T is electrically connected to the corresponding pixel electrode 722. The plurality of pixel units 720 are respectively located in a plurality of pixel regions 3000a defined by the plurality of data lines DL and the plurality of scan lines SL. Each of the pixel regions 3000a includes one first pixel region 700a of the active device substrate 700 and one second pixel region 800a of the opposite substrate 800. Each of the first pixel regions 700a corresponds to one of the second pixel regions 800a. The plurality of first pixel regions 700a are defined by the plurality of data lines DL and the plurality of scan lines SL. That is, the boundary of each of the first pixel regions 700a is defined by two corresponding data lines DL and two corresponding scan lines SL. The plurality of first pixel regions 700a are arranged in an array. Each column of the plurality of first pixel regions 700a is connected into an arc line along the first direction d1. An axial direction d3 passes through each of the first pixel regions 700a and the center of curvature of the arc line C. Each of the first pixel regions 700a forms a first projection on the opposite substrate 800 along the axial direction d3, and the location of the first projection is a second pixel region 800a corresponding to the first pixel region 700a.

The opposite substrate 800 at least includes a second substrate 810 and a network light-shielding pattern 820 disposed between the second substrate 810 and the display medium 900. The network light-shielding pattern 820 is the so-called black matrix. The network light-shielding pattern 820 can be formed by the intertwinement of a plurality of first network lines 822 parallel to one another and a plurality of second network lines 824 parallel to one another. The first network lines 822 and the second network lines 824 are both located between the second substrate 810 and the display medium 900. The first network lines 822 can be parallel to the data lines DL, and the second network lines 824 can be parallel to the scan lines SL. The material of the network light-shielding pattern 820 can be black resin, a metal having low reflectivity (such as chromium or nickel), or other suitable materials. Each of the pixel units 720 further includes a plurality of light-shielding structures located in the corresponding second pixel region 800a, and the light-shielding structures are located on two opposite sides of the pixel electrode 722 and are two first network lines 822 disposed parallel to the data lines DL.

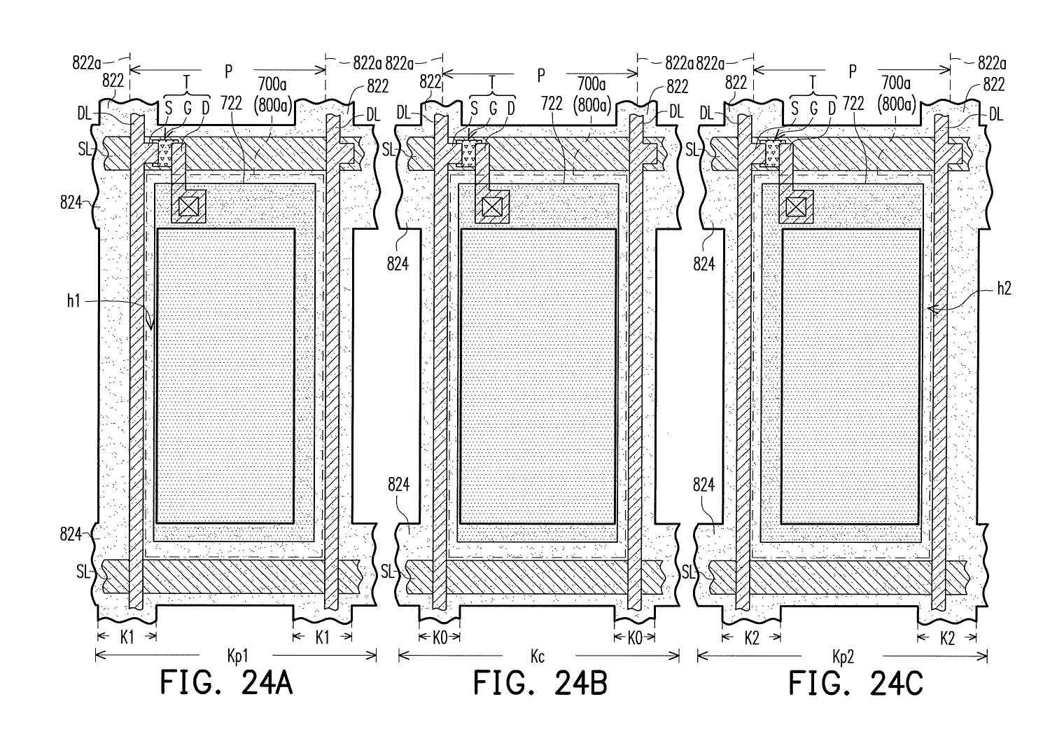

In the curved display panel CDP3, the curved display panel CDP3 has a first peripheral area Kp1, a center area Kc, and a second peripheral area Kp2 sequentially arranged along the first direction d1. In the present embodiment, the curved display panel CDP3 is bended into an arc surface, and the curved display panel CDP3 can be symmetric to a third reference plane passing through the center area Rc. The first peripheral area Kp1 and the second peripheral area Kp2 are respectively located on two opposite sides of the third reference plane. It should be mentioned that, the aperture ratio of at least one of the pixel regions 3000a located in the first peripheral area Kp1 and the aperture ratio of at least one of the pixel regions 3000a located in the second peripheral area Kp2 are smaller than the aperture ratio of at least one of the pixel regions 3000a located in the center area Rc. More specifically, in the present embodiment, the aperture ratio of at least one of the second pixel regions 800a located in the first peripheral area Kp1 and the aperture ratio of at least one of the second pixel regions 800a located in the second peripheral area Kp2 can be smaller than the aperture ratio of at least one of the second pixel regions 800a located in the center area Kc, which is described in the following with FIG. 24A, FIG. 24B, and FIG. 24C.

FIG. 24A shows a second pixel region of FIG. 21 located in a first peripheral area and data lines, scan lines, an active device, and a pixel electrode below the second pixel region. FIG. 24B shows a second pixel region of FIG. 21 located in a center area and data lines, scan lines, an active device, and a pixel electrode below the second pixel region. FIG. 24C shows a second pixel region of FIG. 21 located in a second peripheral area and data lines, scan lines, an active device, and a pixel electrode below the second pixel region. Referring to FIG. 24A and FIG. 24B, the area of two first network lines 822 of the second pixel region 800a located in the first peripheral area Kp1 inside the second pixel region 800a is greater than the area of two first network lines 822 of the second pixel region 800a located in the center area Kc inside the second pixel region 800a. Therefore, the aperture ratio of at least one of the second pixel regions 800a located in the first peripheral area Kp1 is smaller than the aperture ratio of at least one of the second pixel regions 800a located in the center area Kc. Referring to FIG. 24B and FIG. 24C, the area of two first network lines 822 of the second pixel region 800a located in the second peripheral area Kp2 inside the second pixel region 800a is greater than the area of two first network lines 822 of the second pixel region 800a located in the center area Kc inside the second pixel region 800a. Therefore, the aperture ratio of at least one of the second pixel regions 800a located in the second peripheral area Kp2 is smaller than the aperture ratio of at least one of the second pixel regions 800a located in the center area Kc.

Referring to FIG. 24A, FIG. 24B, and FIG. 24C, specifically, in the curved display panel CDP3, a linewidth K1 of each of the two first network lines 822 of the second pixel region 800a located in the first peripheral area Kp1 in the first direction d1 and a linewidth K2 of each of the two first network lines 822 of the second pixel region 800a located in the second peripheral area Kp2 in the first direction d1 are greater than a linewidth K0 of each of the two first network lines 822 of the second pixel region 800a located in the center area Kc in the first direction d1. The two first network lines 822 of the second pixel region 800a located in the first peripheral area Kp1, the two first network lines 822 of the second pixel region 800a located in the second peripheral area Kp2, and the two first network lines 822 of the second pixel region 800a located in the center area Kc are arranged at an equal pitch P in the first direction d1, wherein the pitch P refers to the distance of two central axes 822a of two corresponding first network lines 822 in the first direction d1. The direction of extension of each of the central axes 822a is the same as the direction of extension of a corresponding first network line 822, and each of the central axes 822a passes through the geometric center of a corresponding first network line 822.

As shown in FIG. 24A, although the two first network lines 822 of the second pixel region 800a located in the first peripheral area Kp1 are slightly shifted relative to the two corresponding data lines DL, since the linewidth K1 of each of the two first network lines 822 of the second pixel region 800a located in the first peripheral area Kp1 is greater, the first network lines 822 can still shield a gap h1 between the pixel electrode 822 and the data line DL located on the left side of the pixel electrode 822. As shown in FIG. 24C, although the two first network lines 822 of the second pixel region 800a located in the second peripheral area Kp2 are slightly shifted relative to the two corresponding data lines DL, since the linewidth K2 of each of the two first network lines 822 of the second pixel region 800a located in the second peripheral area Kp2 is greater, the first network lines 822 can still shield a gap h2 between the pixel electrode 822 and the data line DL located on the right side of the pixel electrode 822. Accordingly, the issue of light leakage in the prior art can be alleviated.

It can be known from the comparison of FIG. 24A, FIG. 24B, and FIG. 24C that, the aperture ratio of the second pixel region 800a located in the first and second peripheral areas Kp1 and Kp2 is smaller than the aperture ratio of the second pixel region 800a located in the center area Kc. That is, when three light beams of the same intensity respectively pass through the second pixel region 800a located in the first peripheral area Kp1 and the corresponding first pixel region 700a, the second pixel region 800a located in the second peripheral area Kp2 and the corresponding first pixel region 700a, and the second pixel region 800a located in the center area Kc and the corresponding first pixel region 700a, the amount of light passing through the second pixel region 800a located in the first and second peripheral areas Kp1 and Kp2 and the corresponding first pixel region 700a is smaller than the amount of light passing through the second pixel region 800a located in the center area Kc and the corresponding first pixel region 700a. Therefore, the curved display panel CDP3 can further include a special backlight source, and the light intensity provided by the backlight source to the first and second peripheral areas Kp1 and Kp2 is greater than the light intensity provided to the center area Kc, such that the curved display panel CDP3 has uniform brightness. The special backlight source can also be applied in the curved display panels CDP1 and CDP2, and is not repeated herein.

Based on the above, the curved display panel of an embodiment of the invention is bended along a first direction, and the curved display panel has a first peripheral area, a center area, and a second peripheral area sequentially arranged along the first direction. The aperture ratio of at least one of the pixel regions located in the first peripheral area and the aperture ratio of at least one of the pixel regions located in the second peripheral area are smaller than the aperture ratio of at least one of the pixel regions located in the center area. Via the special design of aperture ratio, the issue of light leakage in the prior art does not readily occur to the curved display panel.

Although the invention has been described with reference to the above embodiments, it will be apparent to one of the ordinary skill in the art that modifications and variations to the described embodiments may be made without departing from the spirit and scope of the invention. Accordingly, the scope of the invention will be defined by the attached claims not by the above detailed descriptions.

What is claimed is:

1. A curved display panel, bended along a first direction, the curved display panel having a first peripheral area, a center area, and a second peripheral area sequentially arranged along the first direction, the curved display panel comprising:
a first substrate;
a plurality of data lines disposed on the first substrate;
a plurality of scan lines disposed on the first substrate and crossed with the data lines;
a plurality of pixel units respectively located in a plurality of pixel regions defined by the data lines and the scan lines, each of the pixel units comprising:
an active device located on the first substrate; and
a pixel electrode located on the first substrate and electrically connected to the active device;
a second substrate opposite to the first substrate; and
a display medium disposed between the first substrate and the second substrate, wherein an aperture ratio of at least one of the pixel regions located in the first peripheral area and an aperture ratio of at least one of the pixel regions located in the second peripheral area are smaller than an aperture ratio of at least one of the pixel regions located in the center area.

2. The curved display panel of claim 1, wherein each of the pixel units further comprises: two light-shielding structures disposed parallel to the two data lines and located on two opposite sides of the pixel electrode of the pixel unit, an area of the two light-shielding structures of the pixel region located in the first peripheral area inside the pixel region is greater than an area of the two light-shielding structures of the pixel region located in the center area inside the pixel region, and an area of the two light-shielding structures of the pixel region located in the second peripheral area inside the pixel region is greater than an area of the two light-shielding structures of the pixel region located in the center area inside the pixel region.

3. The curved display panel of claim 2, wherein the two light-shielding structures of each of the pixel units are located between the display medium and the first substrate.

4. The curved display panel of claim 2, wherein the two light-shielding structures of the pixel region located in the first peripheral area are a first light-shielding structure and a second light-shielding structure, the two light-shielding structures of the pixel region located in the second peripheral area are a third light-shielding structure and a fourth light-shielding structure, the first light-shielding structure, the second light-shielding structure, the third light-shielding structure, and the fourth light-shielding structure are sequentially arranged along the first direction, a linewidth of the first light-shielding structure in the first direction is greater than a linewidth of the second light-shielding structure in the first direction, and a linewidth of the fourth light-shielding structure in the first direction is greater than a linewidth of the third light-shielding structure in the first direction.

5. The curved display panel of claim 1, wherein the pixel units are divided into a plurality of first pixel units and a plurality of second pixel units, each of the first pixel units further comprises a first light-shielding structure and a second light-shielding structure, the first light-shielding structure, the pixel electrode of the first pixel unit, and the second light-shielding structure are sequentially arranged along the first direction, a linewidth of the first light-shielding structure in the first direction is greater than a linewidth of the second light-shielding structure in the first direction, each of the second pixel units further comprises a third light-shielding structure and a fourth light-shielding structure, the third light-shielding structure, the pixel electrode of the second pixel unit, and the fourth light-shielding structure are sequentially arranged along the first direction, and a linewidth of the fourth light-shielding structure in the first direction is greater than a linewidth of the third light-shielding structure in the first direction.

6. The curved display panel of claim 5, wherein the first pixel units and the second pixel units are arranged in nth to (n+m)th rows along the first direction, n and m are both positive integers greater than or equal to 1, and a number of the first pixel units in the nth row is greater than a number of the first pixel units in the (n+m)th row.

7. The curved display panel of claim 5, wherein the first pixel units and the second pixel units are arranged in nth to (n+m)th rows along the first direction, n and m are both positive integers greater than or equal to 1, and a number of the second pixel units in the nth row is less than a number of the second pixel units in the (n+m)th row.

8. The curved display panel of claim 5, wherein the first pixel units and the second pixel units are randomly distributed.

9. The curved display panel of claim 5, wherein the first pixel units and the second pixel units are arranged into a plurality of rows along the first direction, and the first pixel units and the second pixel units in at least one of the rows located in a center portion of the rows are alternately arranged.

10. The curved display panel of claim 9, wherein a number of the first pixel units in the at least one row is the same as a number of the second pixel units in the at least one row.

11. The curved display panel of claim 5, wherein the first pixel units and the second pixel units are arranged into a plurality of rows along the first direction, the first pixel units in each of the rows located in the first peripheral area are concentrated toward a center of the row, a number of the first pixel units in each of the rows located in the first peripheral area is reduced with a decrease in a distance of the row and the center area, the second pixel units in each of the rows located in the second peripheral area are concentrated toward a center of the row, and a number of the second pixel units in each of the rows located in the second peripheral area is reduced with a decrease in a distance of the row and the center area.

12. The curved display panel of claim 5, wherein the first pixel units and the second pixel units are arranged into a plurality of rows along the first direction, a portion of the first pixel units are concentrated in a first area inside the first peripheral area, a width of the first area in a second direction perpendicular to the first direction is increased away from the center area, a portion of the second pixel units are concentrated in a second area inside the second peripheral area, and a width of the second area in the second direction is increased away from the center area.

13. The curved display panel of claim 5, wherein a first gap is between one of the data lines closest to the first light-shielding structure of each of the first pixel units and an edge of the pixel electrode of the first pixel unit, a second gap is between one of the data lines closest to the fourth light-shielding structure of each of the second pixel units and an edge of the pixel electrode of the second pixel unit, and the curved display panel has a third peripheral area, a fourth peripheral area, the first peripheral area, the center area, the second peripheral area, a fifth peripheral area, and a sixth peripheral area sequentially arranged along the first direction.

14. The curved display panel of claim 13, wherein an area of the first gap of each of the first pixel units located in the center area is R1, an area of the first gap shielded by the first light-shielding structure of the first pixel unit located in the center area is A1, 0%≦(A1/R1)≦12.5%, an area of the first gap of each of the first pixel units located in the first peripheral area is R2, an area of the first gap shielded by the first light-shielding structure of the first pixel unit located in the first peripheral area is A2, 12.5%≦(A2/R2)≦81.25%, an area of the first gap of each of the first pixel units located in the fourth peripheral area is R3, an area of the first gap shielded by the first light-shielding structure of the first pixel unit located in the fourth peripheral area is A3, 81.25%≦(A3/R3)≦100%, an area of the first gap of each of the first pixel units located in the third peripheral area is R4, an area of the first gap shielded by the first light-shielding structure of the first pixel unit located in the third peripheral area is A4, and 0%≦(A4/R4)≦18.75%.

15. The curved display panel of claim 13, wherein an area of the second gap of each of the second pixel units located in the center area is R5, an area of the second gap shielded by the fourth light-shielding structure of the second pixel unit located in the center area is A5, 0%≦(A5/R5)≦12.5%, an area of the second gap of each of the second pixel units located in the second peripheral area is R6, an area of the second gap shielded by the fourth light-shielding structure of the second pixel unit located in the second peripheral area is A6, 12.5%≦(A6/R6)≦81.25%, an area of the second gap of each of the second pixel units located in the fifth peripheral area is R7, an area of the second gap shielded by the fourth light-shielding structure of the second pixel unit located in the fifth peripheral area is A7, 81.25%≦(A7/R7)≦100%, an area of the second gap of each of the second pixel units located in the sixth peripheral area is R8, an area of the second gap shielded by the fourth light-shielding structure of the second pixel unit located in the sixth peripheral area is A8, and 0%≦(A8/R8)≦18.75%.

16. The curved display panel of claim 2, wherein the light-shielding structures are located between the second substrate and the display medium.

17. The curved display panel of claim 6, further comprising:
a network light-shielding pattern located between the second substrate and the display medium and formed by an intertwinement of a plurality of first network lines parallel to one another and a plurality of second network lines parallel to one another, wherein the first network lines are parallel to the data lines, and the light-shielding structures are the first network lines.

18. The curved display panel of claim 2, wherein a pitch of the two light-shielding structures of the pixel region located in the first peripheral area and a pitch of the two light-shielding structures of the pixel region located in the second peripheral area are smaller than a pitch of the two light-shielding structures of the pixel region located in the center area.

19. The curved display panel of claim 18, wherein linewidths of the light-shielding structures in the first direction is the same.

20. The curved display panel of claim 18, wherein linewidths of the two light-shielding structures of the pixel region located in the first peripheral area and linewidths of the two light-shielding structures of the pixel region located in the second peripheral area are smaller than linewidths of the two light-shielding structures of the pixel region located in the center area.

21. The curved display panel of claim 18, wherein a relationship between a distance of the pixel region located in the first peripheral area and the center area and a pitch of the two light-shielding structures located inside the pixel region is linear, and a relationship between a distance of the pixel region located in the second peripheral area and the center area and a pitch of the two light-shielding structures located inside the pixel region is linear.

22. The curved display panel of claim 2, wherein linewidths of the two light-shielding structures of the pixel region located in the first peripheral area and linewidths of the two light-shielding structures of the pixel region located in the second peripheral area are greater than linewidths of the two light-shielding structures of the pixel region located in the center area.

23. The curved display panel of claim 22, wherein the light-shielding structures are arranged at an equal pitch.
